(19) United States
(12) Patent Application Publication
(10) Pub. No.: US 2025/0368214 A1
(43) Pub. Date: Dec. 4, 2025

(54) VERIFICATION OF DRIVER BEHAVIOR DURING VEHICLE OPERATION

(71) Applicant: Bendix Commercial Vehicle Systems LLC, Avon, OH (US)

(72) Inventors: Cathy L. BOON, Orange, CA (US); Shaun M. HOWARD, Irvine, CA (US); Andre TOKMAN, San Clemente, CA (US); Andreas U. KUEHNLE, Strangnas (SE)

(21) Appl. No.: 18/679,984

(22) Filed: May 31, 2024

(51) Int. Cl. B60W 50/14; B60W 40/09

(52) U.S. Cl. CPC B60W 50/14; B60W 40/09; B60W 2050/143; B60W 2050/146; B60W 2540/223; B60W 2540/229

(57) ABSTRACT

A system and method controls a vehicle based on driver attention to an operation of the vehicle by receiving a first signal representative of a head pose condition of the driver during a first time period, receiving a second signal representative of a physical characteristic of the vehicle operated during the first time period, determining the driver attention to the operation of the vehicle based on the first and second signals, and generating a signal that adjusts the functional aspect of the associated vehicle, wherein the generated signal causes the associated vehicle to adjust the functional aspect of the vehicle based on the generated signal. The adjusting the functional aspect of the vehicle includes one or more of adjusting a content, timing, format, and/or style of a warning signal generated by the vehicle, and/or adjusting a parameter of one or more driver assistance systems of the vehicle.

### FIELD

The embodiments herein relate generally to monitoring the behavior of drivers operating vehicles and, more particularly, to monitoring the behavior of drivers operating vehicles.

### BACKGROUND

Existing systems and methods in the vehicular fleet management field have in the past focused on specific features of image capture systems and data transmission of files within the image capture systems. For example, U.S. Pat. No. 7,671,762 to Breslau teaches a system and method of transceiving vehicle data that involves transmission of data between two or more vehicles. Specifically, Breslau involves transmission and reception of vehicle identification data between the vehicles, and vehicular position data between the vehicles, and includes the use of Global Position Sensor (GPS) signals and satellite transmission.

Another existing technology is disclosed in U.S. Pat. No. 6,389,340 to Rayner wherein a circuit is taught that captures images based upon occurrences of triggering events, and in which the system components are housed within a rearview mirror of a vehicle such as a car or truck.

U.S. Pat. No. 7,804,426 to Etcheson teaches a system and method for selective review of event data that comprises computer-assisted cueing of driving data for the selective review in order to save time. Live event data is continuously captured during operation of a vehicle and stored directly into a data buffer for later review. The stored event data may be retrieved by a fleet manager or the like for off-vehicle processing by an event detector system at a fleet management location.

In U.S. Pat. No. 9,922,567 to Molin, a system and method is described in which vehicles are configured to collect driver and vehicle event data, and communicate the data to one or more telematics service providers. One or more servers may poll this driver event data periodically, process it, and present multiple methods to end users by which they are able to view and analyze the data. The system described permits fleet managers to use the driver event data received through a report or notification, or queried directly from a web-based portal, to monitor driver behavior, correct and/or reward driver behavior as may be appropriate, initiate driver education and training programs as may be desired, or the like.

It is to be appreciated, however, that driving consists of both simple and complex actions. Therefore, systems that simply detect excesses, improper, or unexpected values during vehicle operation such as for example excessive braking or lane departure actions, or speeding events may fail to detect more complex actions such as for example operator attention. In both the simple and complex driving maneuvers, however, it is important for the driver to be looking in “proper” directions before, during, and after executing the various driving maneuvers. The attention of the driver should be focused or otherwise directed to general areas at any given time during the various maneuvers such as for example, focused forward while highway driving, focused to the proper side when overtaking another vehicle, focused at the dashboard following accelerating the vehicle to highway speeds, etc.

Monitoring systems having both forward-facing cameras as well as driver-facing cameras are known as well. These systems typically capture images of the roadway and of the driver within the interior of the vehicle continuously during operation of a vehicle, wherein the image data is stored in large buffer files, such as first-in-first out (FOFO) buffers, for example. The roadway and driver image data may be sent to an off-vehicle event detector when requested by a remote fleet manager or the like. In that way, the activities of the driver during any selected event can be determined ex-post facto by “winding back” the video of the recorded vehicle operation to the proper time of the occurrence of the selected event.

It is impractical however during operation of a vehicle for systems to monitor video images of both a driver such as may be provided for example by using a driver facing camera, together with images of the driving maneuver such as may be provided for example by using a forward-facing camera disposed on the vehicle. This is because such image processing requires the handling of excessively large amounts of data, the use of high-speed graphics processors or the like, and other image processing techniques that are cumbersome, slow, and cost prohibitive.

It is desirable, therefore, to monitor a driver during vehicle operation more intelligently and efficiently by providing a reduced data set that is descriptive of a driver's head pose and of other parameters associated with operation of the vehicle, and then processing the reduced data set to determine driver behavior, rather than by using the cumbersome raw driver image data that may be acquired by a drive facing camera and/or by using gross vehicle data collection based on data acquired by a vehicle forward-facing camera.

It is further desirable to analyze the one or more particular driver behaviors over the course of time to determine undesirable driver behaviors including undesirable behavior trends, preferably before an occurrence of any significant events, so that the driver or others such as fleet managers or the like may be suitably warned beforehand, if possible that the driver's attention may be flagging and/or otherwise waning.

It is further desirable that the drivers may further be graded relative to safety and other considerations, as well as that the drivers may further be ranked relative to other drivers in the fleet of vehicles, for motivating the drivers to behave better thereby enhancing the overall safety of the fleet and improving overall fleet performance.

### SUMMARY

The embodiments herein provide for new and improved systems and methods for monitoring the behavior of drivers operating vehicles.

The embodiments herein provide for new and improved systems and methods for monitoring the behavior of drivers operating vehicles, and determining a driver's vigilance (actively paying proper attention) to the vehicle operation.

In addition, embodiments herein provide for new and improved systems and methods of monitoring driver behavior taking into consideration physical characteristics of the vehicle during operation of a vehicle.

The embodiments herein further provide for new and improved systems and methods of monitoring driver behavior taking into consideration head pose conditions of the driver operating the vehicle.

The embodiments herein further provide for new and improved systems and methods of monitoring driver behavior based on monitoring a head pose condition of the driver during an operation of the vehicle, together with monitoring one or more physical characteristics of the vehicle during the operation.

The embodiments herein further provide for new and improved systems and methods of monitoring driver behavior based on monitoring a head pose condition of the driver during a maneuver of the vehicle, together with monitoring one or more physical characteristics of the vehicle during the maneuver.

The embodiments herein further provide for new and improved systems and methods of monitoring driver behavior based on monitoring a head pose condition of the driver during a plurality of different maneuvers of the vehicle, together with monitoring one or more physical characteristics of the vehicle during the plurality of different maneuvers.

Particular embodiments further relate to using results of the monitoring of the driver behavior for enhancing the safety of the vehicles and for helping to improve the performance of the drivers.

In any of the embodiments, driver attention to the operation of a vehicle is determined indirectly relative to raw driver image data captured by a camera. The raw driver image data captured by the camera is reduced. The driver's attention to the operation of a vehicle is determined indirectly relative to raw driver image data captured by the camera and is based on the reduced data set that is descriptive of a driver's head pose.

In any of the embodiments, driver attention to the operation of a vehicle is monitored as the monitored behavior, wherein a functional aspect of the vehicle may be adjusted based on the determined driver attention.

In any of the embodiments, driver attention during a maneuver of a vehicle is monitored as the monitored behavior, wherein a functional aspect of the vehicle may be adjusted based on the determined driver attention to the maneuver.

In any of the embodiments, driver attention to vehicle operation during a plurality of maneuvers of the vehicle is monitored as the monitored behavior, wherein a functional aspect of the vehicle may be adjusted based on the determined driver attention to the plurality of maneuvers.

In any of the embodiments, driver attention to vehicle operation during a plurality of maneuvers of the vehicle is monitored as a driver attention trend over a period of time as the monitored behavior, wherein a functional aspect of the vehicle may be adjusted based on the determined driver attention to the plurality of maneuvers.

In any of the embodiments, the functional aspect of the vehicle are adjusted by generating a signal that adjusts a functional aspect of the vehicle based on the determined driver attention.

In any of the embodiments, the functional aspect of the vehicle are adjusted by generating a signal based on the determined driver attention, wherein the associated vehicle is responsive to the signal to in turn make the requested adjustments to the one or more functional aspect of the vehicle.

In accordance with an aspect of the disclosure a method is provided for determining a driver attention to operation of a vehicle. The method includes receiving a first signal representative of a head pose condition of the driver during a first time period, receiving a second signal representative of a physical characteristic of the vehicle operated during the first time period, and determining the driver attention to the operation of the vehicle based on the first and second signals.

In any of the embodiments herein, the method further includes adjusting functional aspect of the vehicle based on the determined driver attention.

In any of the embodiments herein, the adjusting the functional aspect of the vehicle includes generating a driver attention score signal representative of the determined driver attention and delivering the driver attention score signal to the associated vehicle, wherein the associated vehicle is responsive to the driver attention score signal to effect the adjustment of the functional aspect.

In any of the embodiments herein, the receiving the first signal includes receiving a first set of time series data representative of the head pose condition of the driver during the first time period, the receiving the second signal includes receiving a second set of time series data representative of the physical characteristic of the vehicle operated during the first time period, and the determining the driver attention to the operation of the vehicle includes processing the first and second sets of time series data to determine the driver attention to the operation based on the first and second sets of time series data processed by a neural network.

In any of the embodiments herein, the receiving the first signal includes receiving a first set of time series data representative of the head pose condition of the driver during the first time period, the receiving the second signal includes receiving a second set of time series data representative of the physical characteristic of the vehicle operated during the first time period, and the determining the driver attention to the operation of the vehicle includes neural network processing the first and second sets of time series data to determine the driver attention to the operation based on the first and second sets of time series data processed by a neural network.

In any of the embodiments herein, the receiving the first signal includes receiving a first set of time series data representative of the head pose condition of the driver during a first time period, and the receiving the second signal includes receiving a second set of time series data representative of the physical characteristic of the vehicle operated during a second time period, wherein the second time period lags or is otherwise offset from the first time period by a predetermined and/or selected time period. In accordance with an example implementation, driver gaze typically leads steering by about one (1) second. Driver condition may then be derived by correlation analysis of head yaw and steering angle, looking what time delay exists. In an implementation, the first set of time series data representative of the head pose (yaw, etc.) condition of the driver during the first time period may lead the second signal comprising the second set of time series data representative of the steering angle physical characteristic of the vehicle operated during the second time period that lags the first time period by about 1 second or the like.

In any of the embodiments herein, the receiving the first signal includes receiving a first set of time series data representative of the head pose condition of the driver during a first time period over a protracted time period for performing a trend analysis on the driver's head control and, similarly, the receiving the second signal includes receiving a second set of time series data representative of the physical characteristic of the vehicle operated during a second time period over a protracted time period for performing trend analysis on vehicle control. In an example implementation, head pose trending and the driver making more mistakes may be determined. For instance, as fatigue sets in the driver's head may droop more often and the frequency of lane departures and other safety events may increase. In an example implementation, trend analysis is used to detect the drooping and increasing event frequency. If the driver's head droop trend continues, then it may be expected that an unacceptable threshold event rate will be reached, in which case we should alter vehicle behavior beforehand.

In any of the embodiments herein, the driver's head pose condition (head yaw lead and head droop, etc.) form the one time series, and the vehicle data (event rate or steering angle) form the other timer series.

In any of the embodiments herein, the determining the driver attention to the operation of the vehicle includes neural network processing time series data signals received by the neural network and consisting essentially of the first set of time series data, and the second set of time series data.

In any of the embodiments herein, the determining the driver attention to the operation of the vehicle includes neural network processing time series data signals received by the neural network and consisting of the first set of time series data, and the second set of time series data.

In any of the embodiments herein, the receiving the first signal includes receiving a first set of time series data representative of the head pose condition of the driver during the first time period, the receiving the second signal includes receiving a second set of time series data representative of the physical characteristic of the vehicle operated during the first time period, the determining the driver attention to the operation of the vehicle includes neural network processing the first and second sets of time series data to determine a maneuver performed by the driver operating the vehicle and the driver attention to the maneuver, and the adjusting the functional aspect of the vehicle includes adjusting the functional aspect of the vehicle based on the determined driver attention to the maneuver.

In any of the embodiments herein, the determining the driver attention to the maneuver includes determining the driver attention to the maneuver as a current attention score based on the neural network processing the first and second sets of time series data based on driver attention scores trained to a neural network relative to sets of head pose conditions and associated physical characteristics of the vehicle operated during a plurality of training sessions of the vehicle performing the maneuver, and the adjusting the functional aspect of the vehicle includes adjusting the functional aspect of the vehicle based on the determined current attention score.

In any of the embodiments herein, the determining the maneuver performed by the driver operating the vehicle includes determining the maneuver as a particular maneuver based on the neural network processing the first and second sets of time series data based on driver attention scores trained to a neural network relative to sets of head pose conditions and associated physical characteristics of the vehicle operated during a plurality of training sessions to the neural network of the vehicle performing the particular maneuver, and the adjusting the functional aspect of the vehicle includes adjusting the functional aspect of the vehicle based on the determined current attention score.

In any of the embodiments herein, the method further includes transmitting the first signal representative of the head pose condition of the driver during the first time period to an associated processing system, and transmitting the second signal representative of the physical characteristic of the vehicle operated during the first time period to the associated processing system, wherein the determining the driver attention to the operation of the vehicle includes receiving an operator attention signal from the associated processing system, wherein the received operator attention signal is representative of the driver attention to the operation of the vehicle based on the first and second signals transmitted to the associated processing system.

In any of the embodiments herein, the receiving the first signal includes receiving a first set of time series data representative of the head pose condition of the driver during the first time period, the receiving the second signal includes receiving a second set of time series data representative of the physical characteristic of the vehicle operated during the first time period, the transmitting the first signal to the associated processing system includes transmitting the first set of time series data to the associated processing system, and the transmitting the second signal to the associated processing system includes transmitting the second set of time series data to the associated processing system.

In any of the embodiments herein, the method further includes receiving a further first signal representative of the head pose condition of the driver during a second time period after the first time period, receiving a further second signal representative of the physical characteristic of the vehicle operated during the second time period, determining a further driver attention to the operation of the vehicle based on the further first and second signals, determining flagging driver attention to the operation of the vehicle by a comparison between the driver attention determined based on the first and second signals and the further driver attention determined based on the further first and second signals, and adjusting a further functional aspect of the vehicle based on the determined flagging driver attention.

In any of the embodiments herein, the adjusting the functional aspect of the vehicle based on the determined driver attention includes one or more of adjusting a content of a warning signal generated by the vehicle for warning the driver of potential danger relating to the vehicle operation, adjusting a timing of a warning signal generated by the vehicle for warning the driver of potential danger relating to the vehicle operation, adjusting a format of a warning signal generated by the vehicle for warning the driver of potential danger relating to the vehicle operation, adjusting a style of a warning signal generated by the vehicle for warning the driver of potential danger relating to the vehicle operation, and/or adjusting a parameter of one or more driver assistance systems of the vehicle.

In any of the embodiments herein, the adjusting the functional aspect of the vehicle includes generating a signal that adjusts the functional aspect of the associated vehicle, wherein the generated signal causes the associated vehicle to adjust the functional aspect of the vehicle based on the generated signal.

The various examples described above can be combined with each other in further examples.

It is to be understood that the features mentioned above and those yet to be explained below may be used not only in the respective combinations indicated, but also in other combinations or in isolation without departing from the scope of the invention.

Other aspects, embodiments, features and advantages of the example embodiments will become apparent from the following description of the embodiments, taken together with the accompanying drawings, which illustrate, by way of example, the principles of the example embodiments.

### BRIEF DESCRIPTION OF THE DRAWINGS

In the accompanying drawings which are incorporated in and constitute a part of the specification, embodiments of the implementations are illustrated, which, together with a general description of the implementations given above, and the detailed description given below, serve to exemplify the embodiments of this description.

FIG. 1 is a schematic block diagram depiction that illustrates details of a vehicle control apparatus disposed in a representative associated vehicle in accordance with an example embodiment.

FIG. 2 is a functional block diagram depiction that illustrates details of a system providing verification of proper driver head pose during vehicle operation in accordance with an example embodiment.

FIG. 3 is a functional block diagram depiction that illustrates details of a system 300 providing an indication of a flagging or waning driver attention to vehicle operation over time in accordance with a further example embodiment.

FIG. 4 is a plot representation of separate driver vigilance activities against time useful for determining vigilance scores.

FIG. 5 is a pictogram showing details of data collection and manipulation for verifying driver head pose during maneuvers of a vehicle in accordance with an example embodiment.

FIG. 6 is a functional block diagram depiction that illustrates a training system providing for training a driver attention processing component in accordance with an example embodiment.

FIGS. 7A-7I are pictograms showing steps in training a neural network formed by a processor device executing neural network logic stored in a memory device in accordance with an example embodiment.

FIG. 8 is a graph showing a yaw time history corresponding to the pictograms of FIGS. 7A-7I used in training the neural network formed by a processor device executing neural network logic stored in a memory device in accordance with an example embodiment.

FIG. 9 is a flow diagram showing a method of controlling a vehicle based on driver attention to an operation of the vehicle in accordance with an example embodiment.

FIG. 10 is a flow diagram showing a method of controlling a vehicle based on driver attention to an operation of the vehicle in accordance with an example embodiment.

### DETAILED DESCRIPTION OF THE EXAMPLE EMBODIMENTS

In the following description of the present invention reference is made to the accompanying figures which form a part thereof, and in which are shown, by way of illustration, exemplary embodiments illustrating the principles of the disclosed methods and apparatus verifying driver behavior during vehicle operation. The embodiments herein relate generally to methods and apparatus monitoring the behavior of drivers operating vehicles, and selectively controlling one or more functional aspects of the vehicle based on the determined driver behavior.

The embodiments herein further relate generally to methods and apparatus verifying proper driver head pose during vehicle operation, and using driver head pose for selectively controlling one or more functional aspects of the vehicle based on determined head pose relative to a proper head pose. The embodiments herein further relate generally to methods and apparatus verifying proper driver head pose relative to vehicle operation data, and using driver head pose relative to the vehicle operation data for selectively controlling one or more functional aspects of the vehicle based on determined head pose relative to a proper head pose.

The embodiments herein further relate generally to methods and apparatus verifying proper driver head pose relative to vehicle operation data as the driver is performing a maneuver with the vehicle, and using driver head pose relative to the vehicle operation data as the driver is performing the maneuver with the vehicle for selectively controlling one or more functional aspects of the vehicle based on determined head pose relative to a proper head pose.

The embodiments herein further relate generally to methods and apparatus verifying proper driver head pose relative to vehicle operation data as the driver is performing a series of maneuvers with the vehicle, and using driver head pose relative to the vehicle operation data as the driver is performing the series of maneuvers with the vehicle for selectively controlling one or more functional aspects of the vehicle based on determined head pose relative to a proper head pose.

The embodiments herein further relate generally to methods and apparatus verifying proper driver head pose relative to vehicle operation data as the driver is performing a series of maneuvers with the vehicle over one or more selected time periods, and using driver head pose relative to the vehicle operation data as the driver is performing the series of maneuvers with the vehicle over one or more selected time periods for selectively controlling one or more functional aspects of the vehicle based on determined head pose relative to a proper head pose.

Other embodiments can be utilized to practice the disclosed verification of driver behavior during vehicle operation apparatus and method and structural and functional changes can be made thereto without departing from the scope of the disclosure.

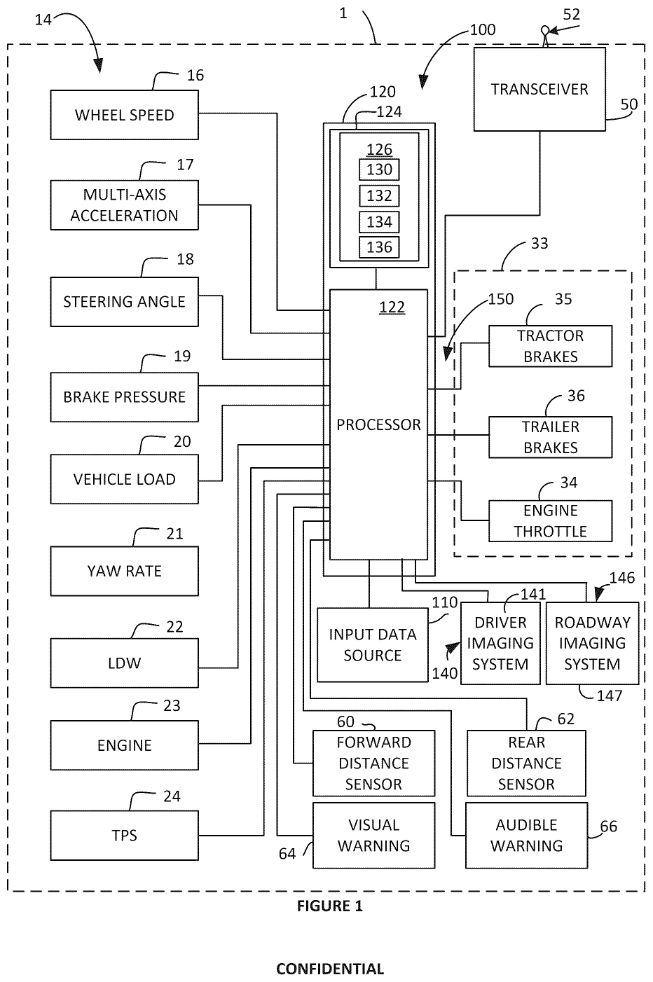

Referring now to the drawings, wherein the showings are for the purpose of illustrating the example embodiments only, and not for purposes of limiting the same, FIG. 1 is a schematic embodiment of a data collection module portion of a driver behavior monitoring system according to the example embodiment.

FIG. 1 is a schematic block diagram depiction that illustrates details of a vehicle control apparatus 100 disposed in a representative associated vehicle 1 in accordance with an example embodiment. According to principles of the example embodiment as illustrated, the control apparatus 100 may be adapted to detect, monitor, and report a variety of operational parameters and conditions of the vehicle 1 and the driver's interaction therewith, and to selectively intervene and take corrective action as may be needed or desired such as, for example, to maintain vehicle stability, to maintain a desired vehicle following distance relative to other vehicles on a roadway, or to maintain any similar desirable vehicle operational characteristics.

In the embodiments herein, the vehicle control apparatus 100 monitors the behavior of drivers operating vehicles. In an embodiment, the vehicle control apparatus 100 monitors the behavior of drivers operating vehicles taking into consideration physical characteristics of the vehicle during various vehicle maneuvers and determined driver behavior during the maneuvers. Particular embodiments further relate to using results of the monitoring the behavior for enhancing the safety of the vehicles and for helping to improve the performance of the drivers.

In an embodiment, the vehicle control apparatus 100 monitors the behavior of drivers operating vehicles taking into consideration head pose conditions of the driver operating the vehicle. In the embodiments herein, the vehicle control apparatus 100 monitors the behavior of drivers operating vehicles based on monitoring a head pose condition of the driver during the operation of the vehicle, together with monitoring one or more physical characteristics of the vehicle during the operation. In the embodiments herein, the vehicle control apparatus 100 monitors the behavior of drivers operating vehicles based on monitoring a head pose condition of the driver during a maneuver of the vehicle, together with monitoring one or more physical characteristics of the vehicle during the maneuver. In the embodiments herein, the vehicle control apparatus 100 monitors the behavior of drivers operating vehicles based on monitoring a head pose condition of the driver during a plurality of different maneuvers of the vehicle, together with monitoring one or more physical characteristics of the vehicle during the plurality of different maneuvers. In the embodiments herein, the vehicle control apparatus 100 monitors the behavior of drivers operating vehicles, wherein a functional aspect of the vehicle may be adjusted based on the determined driver attention. In some embodiments herein, the driver attention is inferred or otherwise determined based on determined driver's head pose relative to vehicle operational data. In the embodiments herein, the vehicle control apparatus 100 monitors the behavior of drivers operating vehicles during a maneuver of a vehicle, wherein one or more functional aspects of the vehicle may be adjusted based on the determined driver attention to the maneuver. In the embodiments herein, the vehicle control apparatus 100 monitors the behavior of drivers operating vehicles during a plurality of maneuvers of a vehicle, wherein one or more functional aspects of the vehicle may be adjusted based on the determined driver attention to the plurality of maneuvers. In the embodiments herein, the vehicle control apparatus 100 monitors the behavior of drivers operating vehicles during a plurality of maneuvers of a vehicle as a driver attention trend over a period of time as the monitored behavior, wherein a functional aspect of the vehicle may be adjusted based on the determined driver attention trend during the plurality of maneuvers.

In the exemplary embodiment of FIG. 1, the control apparatus 100 may interact with one or more devices or systems 14 for providing input data indicative of one or more operating parameters or one or more conditions of the vehicle 1. For example, the devices may be one or more sensors, such as but not limited to, one or more wheel speed sensors 16, one or more acceleration sensors such as multi-axis acceleration sensors 17, a steering angle sensor 18, a brake pressure sensor 19, one or more vehicle load sensors 20, a yaw rate sensor 21, a lane departure warning (LDW) sensor or system 22, one or more engine speed or condition sensors 23, and a tire pressure (TPMS) monitoring system 24. In the example embodiment illustrated, the control apparatus 100 may interact with one or more additional devices or systems in particular that provide input data indicative of one or more additional operating parameters or one or more conditions of the vehicle 1 such as for example, a forward distance sensor 60, and a rear distance sensor 62. Other sensors and/or actuators or power generation devices or combinations thereof may be used of otherwise provided as well, and one or more devices or sensors may be combined into a single unit as may be necessary and/or desired.

In addition and in the exemplary embodiment of FIG. 1, the control apparatus 100 may interact with one or more further devices or vehicle systems 33 for adjusting one or more functional aspects of the vehicle based on determined driver attention during operation of the vehicle 1 such as for example during one or more maneuvers, and also for example for adjusting one or more functional aspects of the vehicle based on driver behavior during a plurality of maneuvers of a vehicle as a driver attention trend over a period of time. The control apparatus 100 may interact with one or more further devices or vehicle systems 33 for adjusting braking functional aspects of the vehicle, throttle functional aspects of the vehicle, and/or steering functional aspects of the vehicle based on determined driver attention during operation of the vehicle 1. In addition, the control apparatus 100 may interact with the driver using functional aspects of the vehicle by providing visual warnings to the driver via a visual warning device 64 and/or by providing audible warnings to the driver via an audible warning device 66.

The control apparatus 100 of the example embodiment includes an electronic control unit (ECU) 120 operatively coupled with the one or more devices or systems 14 described above. The control apparatus 100 is also coupled in the example embodiment with an input data source 110, a driver imaging system 140, and a roadway imaging system 146. The ECU 120 is in general configured to receive vehicle control signals from an input data source 110 to effect various operations in the associated vehicle 1. In the implementation, the ECU 120 includes a processor device 122, a non-transitory memory device 124 operatively coupled with the processor device 122, and vehicle control logic 126 stored in the memory device 124. The vehicle control logic 126 is executable by the processor device 122 to generate vehicle control signals 150 to perform various control operations including for example braking and throttle control operations in the associated vehicle 1 based on execution of the logic 126 by the processor device 122 during operation of the vehicle 1. In an implementation and as will be described in greater detail herein, the vehicle control logic 126 may include one or more of head pose determining logic 130, pre/post event (PPE) determining logic 132, neural network logic 134, and/or flagging determination logic 136, all of which are stored in the memory device 124.

In the example embodiment illustrated and described herein, the processor 122 may include one or more inputs for receiving input data from the devices or systems 14, and one or more outputs for communicating signals to the one or more devices or vehicle systems 33 for adjusting one or more functional aspects of the vehicle based on determined driver attention during operation of the vehicle 1. The processor device 122 may be adapted to process the input data and compare the raw or processed input data to one or more stored threshold values, or to process the input data and compare the raw or processed input data to one or more circumstance-dependent desired value. The processor device 122 may also include one or more outputs for delivering control signals 150 to one or more vehicle systems 33 based on the comparison. The control signals 150 may instruct the systems 33 to intervene in the operation of the vehicle to initiate corrective action, and then report this corrective action to a wireless service (not shown) or simply store the data locally to be used for determining a driver quality. For example, the processor device 122 may generate and send the control signal to an engine electronic control unit or an actuating device to reduce or otherwise retard or close the engine throttle 34 and slowing the vehicle down (decelerating the vehicle). In addition, the processor device 122 may generate and send the control signal to the engine electronic control unit or an actuating device to increase or otherwise advance or open the engine throttle 34 and speeding the vehicle up (accelerating the vehicle). Further, the processor device 122 may send the control signals to one or more vehicle brake systems 35, 36 to selectively engage the brakes. In a tractor-trailer arrangement of the example embodiment, the processor device 122 may engage the brakes 36 on one or more wheels of a trailer portion of the vehicle via a trailer pressure control device (not shown), and the brakes 35 on one or more wheels of a tractor portion of the vehicle 1, and then report this corrective action to the wireless service or simply store the data locally to be used for determining a driver quality. A variety of corrective and/or other actions may be possible and multiple corrective actions may be initiated at the same time. In addition, any of the operating parameters of the vehicle such as, for example, operating parameters of any of the one or more devices or vehicle systems 33 including also for example any of the preexisting systems in the vehicle such as for example advanced antilock brake control systems and/or electronic stability control systems, may be adjusted based on the determined driver behavior. The control apparatus 100 may interact with one or more further devices or vehicle systems 33 for adjusting braking functional aspects of the vehicle, throttle functional aspects of the vehicle, and/or steering functional aspects of the vehicle based on determined driver attention during operation of the vehicle 1. In addition, the control apparatus 100 may interact with the driver using functional aspects of the vehicle by providing visual warnings to the driver via a visual warning device 64 and/or by providing audible warnings to the driver via an audible warning device 66.

In addition, the processor device 122 may generate and send one or more control signals to the visual warning device 64 and/or to the audible warning device to provide visual and/or audible warnings to the driver via these devices 64, 66.

The sensors 14 and ECU 120 may be part of a preexisting system or use components of a preexisting system. For example, the Bendix® ABS-6™ Advanced Antilock Brake Controller with ESP® Stability System commercially available from Bendix Commercial Vehicle Systems LLC may be installed on the vehicle. The Bendix® ESPR system may utilize some or all of the sensors described in FIG. 1. The logic component of the Bendix® ESPR system resides on the vehicle's antilock brake system electronic control unit, which may be used for the processor 122 of the present invention. Therefore, many of the components to support the vehicle control apparatus 100 of the present disclosure may be present in a vehicle equipped with the Bendix® ESP® system, thus, not requiring the installation of additional components. The vehicle control apparatus 100, however, may utilize independently installed components if desired. Further, an IMX.6 processor separate from the ESP system may execute the functions described herein.

The vehicle control apparatus 100 may also include additional sources of input data including for example an input from a forward distance sensor 60 that generates a signal indicative of a distance to a vehicle ahead of the vehicle 1, and a rear-facing sensor 62 that generates a signal representative of a distance to a vehicle behind of the vehicle 1. The vehicle control apparatus 100 may generate a signal to actuate a visual warning device 64 for visually alerting the driver of a potential event that might need attention such as for example a visual warning of an impending forward collision permitting the driver to react by applying brakes, for example, or visual warning of an impending rearward collision permitting the driver to react prior to a collision while backing up the vehicle. The vehicle control apparatus 100 may similarly generate an audible signal to actuate an audible warning device 66 for audibly alerting the driver of a potential event that might need attention such as for example an audible annunciation of a warning of an impending forward collision permitting the driver to react by applying brakes, for example, or an audible annunciation of an impending rearward collision permitting the driver to react prior to a collision while backing up the vehicle.

In addition, the control apparatus 100 is operatively coupled with a driver imaging system 140 that may comprise one or more imaging devices shown in the example embodiment for simplicity and ease of illustration as a single driver facing camera 141 representation of one or more physical video cameras disposed on the vehicle such as, for example, a video camera in operative communication with the control apparatus 100 and disposed in the cab of a commercial vehicle directed so as to obtain an image of the driver. In addition, the control apparatus 100 is operatively coupled with the roadway imaging system 146 shown in the example embodiment for simplicity and ease of illustration as a single forward-facing camera (FFC) 147 disposed on the vehicle in a manner to record images of the roadway ahead of the vehicle, or, as in the example embodiment. It is to be appreciated that the roadway imaging system 146 may comprise a plurality of cameras including one or more FFCs, and one or more rear and/or side facing cameras (RFCs) as may be desired. The roadway imaging system 146 may comprise cameras disposed in general at all four corners of the vehicles such as to provide a 360° surround image of the roadway ahead of the vehicle as well as behind and to the left and right sides. In the example embodiments, driver behavior is monitored directly using the driver facing camera 141 in accordance with a detected head position of the driver within the vehicle being operated by the vehicle, the details of which will be elaborated below. In further example embodiments, the driver behavior is monitored directly using the driver facing camera 141 in accordance with a detected head pose of the driver. For purposes of this description of the example embodiments and for ease of reference, “head pose” is that set of angles describing the orientation of the driver's head, that is, pitch (driver looking down or up), yaw (driver looking left or right), and roll (driver tilting his/her head to the left or right). In still further embodiments, driver behavior is monitored indirectly using the driver facing camera 141 in accordance with detected aspects of components of the vehicle being operated by the driver, the details of which will be elaborated below. The driver facing camera 141 may include an imager available from Ominivision™ as part/model number 10635, although any other suitable equivalent imager may be used as necessary or desired.

In the example embodiment illustrated and described herein, the control apparatus 100 may deliver control signals 150 to one or more vehicle systems 33 based also on the determined driver behavior. The control signals 150 may instruct the systems 33 to intervene in the operation of the vehicle to initiate corrective action based on the determined driver behavior, and then report this corrective action to a wireless service (not shown) or simply store the data locally to be used for determining a driver quality. For example, the processor device 122 may generate and send the control signal to an engine electronic control unit or an actuating device to reduce or otherwise retard or close the engine throttle 34 and slowing the vehicle down (decelerating the vehicle) based on the determined driver behavior. In addition, the processor device 122 may generate and send the control signal to the engine electronic control unit or an actuating device to increase or otherwise advance or open the engine throttle 34 and speeding the vehicle up (accelerating the vehicle) based on the determined driver behavior. Further, the processor device 122 may send the control signals to one or more vehicle brake systems 35, 36 to selectively engage the brakes based on the determined driver behavior. In a tractor-trailer arrangement of the example embodiment, the processor device 122 may engage the brakes 36 on one or more wheels of a trailer portion of the vehicle via a trailer pressure control device (not shown), and the brakes 35 on one or more wheels of a tractor portion of the vehicle 1 based on the determined driver behavior, and then report this corrective action to the wireless service or simply store the data locally to be used for determining a driver quality. A variety of corrective and/or other actions may be possible and multiple corrective actions may be initiated at the same time based on the determined driver behavior. In addition, any of the operating parameters of the vehicle such as, for example, operating parameters of any of the one or more devices or vehicle systems 33 including also for example any of the preexisting systems in the vehicle such as for example advanced antilock brake control systems and/or electronic stability control systems, may be adjusted based on the determined driver behavior. The control apparatus 100 may interact with one or more further devices or vehicle systems 33 for adjusting braking functional aspects of the vehicle, throttle functional aspects of the vehicle, and/or steering functional aspects of the vehicle based on determined driver attention during operation of the vehicle 1. In addition, the control apparatus 100 may interact with the driver using functional aspects of the vehicle by providing visual warnings to the driver via a visual warning device 64 and/or by providing audible warnings to the driver via an audible warning device 66.

Still yet further, the control apparatus 100 may also include a transmitter/receiver (transceiver) module 50 such as, for example, a radio frequency (RF) transmitter including one or more antennas 52 for wireless communication of automated deceleration requests, GPS data, one or more various vehicle configuration and/or condition data, or the like between the vehicles and one or more destinations such as, for example, to one or more wireless services (not shown) having a corresponding receiver and antenna. The transmitter/receiver (transceiver) module 50 may include various functional parts of sub portions operatively coupled with the control unit including for example a communication receiver portion, a global position sensor (GPS) receiver portion, and a communication transmitter. For communication of specific information and/or data, the communication receiver and transmitter portions may include one or more functional and/or operational communication interface portions as well.

The control apparatus 100 is operative to communicate the acquired data to the one or more receivers in a raw data form, that is without processing the data, in a processed form such as in a compressed form, in an encrypted form or both as may be necessary or desired. In this regard, the control apparatus 100 may combine selected ones of the vehicle parameter data values into processed data representative of higher-level vehicle condition data such as, for example, data from the multi-axis acceleration sensors 17 may be combined with the data from the steering angle sensor 18 to determine excessive curve speed event data. Other hybrid event data relatable to the vehicle and driver of the vehicle and obtainable from combining one or more selected raw data items form the sensors includes, for example and without limitation, excessive braking event data, excessive curve speed event data, lane departure warning event data, excessive lane departure event data, lane change without turn signal event data, loss of video tracking event data, LDW system disabled event data, distance alert event data, forward collision warning event data, haptic warning event data, collision mitigation braking event data, ATC event data, ESC event data, RSC event data, ABS event data, TPMS event data, engine system event data, average following distance event data, average fuel consumption event data, and average ACC usage event data. Importantly, however, and in accordance with the example embodiments described herein, the control apparatus 100 is operative to store the acquired image data of the driver and/or of the interior of the vehicle in the memory 124, and to selectively communicate the acquired driver and vehicle interior image data to the one or more receivers via the transceiver 50.

The vehicle control apparatus 100 of FIG. 1 is suitable for executing embodiments of one or more software systems or modules that perform vehicle operational and control strategies according to the subject application. The example vehicle ECU 120 of the vehicle control apparatus 100 may include a bus or other communication mechanism for communicating information, and a processor device 122 coupled with the bus for processing information. The computer system includes a main memory device 124, such as random access memory (RAM) or other dynamic storage device for storing information and instructions to be executed by the processor device 122, and read only memory (ROM) or other static storage device for storing static information and instructions for the processor device 122. Other storage devices may also suitably be provided for storing information and instructions as necessary or desired.

Instructions may be read into the main memory device 124 from another computer-readable medium, such as another storage device of via the transceiver 50. Execution of the sequences of instructions contained in main memory device 124 causes the processor device 122 to perform the process steps described herein. In an alternative implementation, hard-wired circuitry may be used in place of or in combination with software instructions to implement the invention. Thus implementations of the example embodiments are not limited to any specific combination of hardware circuitry and software.

In accordance with the descriptions herein, the term “computer-readable medium” as used herein refers to any non-transitory media that participates in providing instructions to the processor device 122 for execution. Such a non-transitory medium may take many forms, including but not limited to volatile and non-volatile media. Non-volatile media includes, for example, optical or magnetic disks. Volatile media includes dynamic memory for example and does not include transitory signals, carrier waves, or the like. Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, PROM, and EPROM, a FLASH-EPROM, any other memory chip or cartridge, or any other tangible non-transitory medium from which a computer can read.

In addition and further in accordance with the descriptions herein, the term “logic”, as used herein with respect to the Figures, includes hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components.

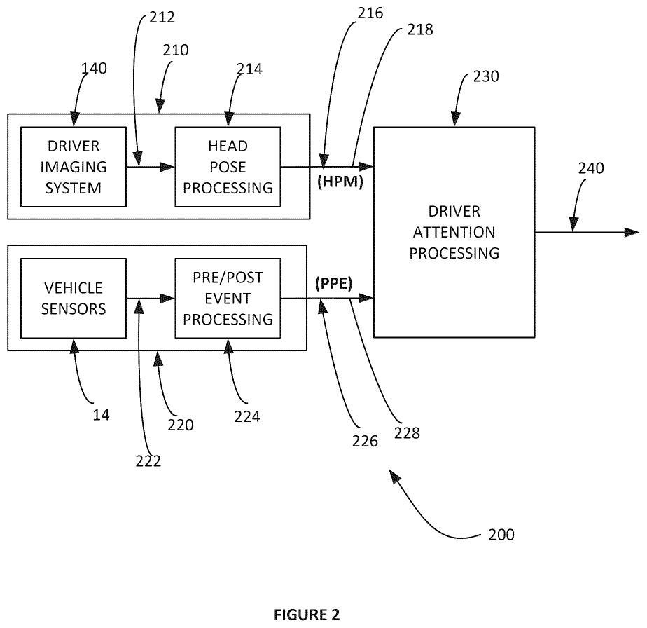

FIG. 2 is a functional block diagram depiction that illustrates details of a system 200 providing verification of proper driver vigilance (actively paying attention) during vehicle operation in accordance with an example embodiment. The system 200 in general includes a driver video/image processing component 210, a vehicle sensor data processing component 220, and a trained network processing component 230, that collectively render a driver attention score signal 240.

In an implementation and as will be described in greater detail herein, the driver video/image processing component 210 may comprise portions of the vehicle control apparatus 100 including for example the processor 122 of the vehicle control apparatus 100 executing the head pose determining logic 130 stored in the memory device 124.

In an implementation and as will be described in greater detail herein, the vehicle sensor data processing component 220 may comprise portions of the vehicle control apparatus 100 including for example the processor 122 of the vehicle control apparatus 100 executing the PPE determining logic 132 stored in the memory device 124.

In an implementation and as will be described in greater detail herein, the trained network processing component 230 may comprise portions of the vehicle control apparatus 100 including for example the processor 122 of the vehicle control apparatus 100 executing the neural network logic 134 stored in the memory device 124.

In general, the system 200 determines driver attention to current (present) and/or continuous (ongoing) operation(s) of the vehicle based on historical data regarding the same or different drivers performing the operation of the vehicle in ranges of states of attentiveness, and renders or otherwise generates or outputs a driver attention score signal 240 representative of the determined driver attention. One or more functional aspect of the vehicle may selectively be adjusted based on the driver attention score signal 240 representative of the determined driver's vigilance (actively paying attention).

In general and further, the system 200 determines driver attention during a plurality of maneuvers of a vehicle as a driver attention trend over a period of time as a monitored behavior, wherein one or more functional aspects of the vehicle may selectively be adjusted based on the determined driver attention to the plurality of maneuvers over the time period of the detected inattention trend.

With reference again to FIG. 2, it is to be appreciated that in accordance with an example embodiment, the driver attention score signal 240 that is generated and representative of the determined driver attention may be used as desired including for example to selectively adjust one or more functional aspect of the vehicle based on the determined driver attention score. The adjusting the functional aspect of the vehicle based on the determined driver attention may comprise, for example, one or more of adjusting a content of a warning signal generated by the vehicle for warning the driver of potential danger relating to the vehicle operation, adjusting a format of the warning signal, and/or adjusting a style of the warning signal. In this regard, the adjusting the functional aspect of the vehicle based on the determined driver attention may comprise, for example, one or more of adjusting a content of an audible and/or visual warning signal generated by the audible and/or visual warning devices 64, 66 of the vehicle for warning the driver of potential danger, adjusting a format of the audible and/or visual warning signal(s), and/or adjusting a style of the audible and/or visual warning signal(s).

In further addition, the adjusting the functional aspect of the vehicle based on the determined driver attention may comprise, for example, one or more of making one or more changes to a warning setting, adding a new or additional sound to a warning, add a new or additional light to a warning, add an audible human intelligible instruction to a warning, add a new warning, adding sound to an existing light-only warning, add light to an existing sound-only warning, making a change to a nature of a warning setting, increasing a volume of an existing sound warning, adding flash/strobe to an existing light warning, increasing a flash frequency of an existing flashing light warning, making changes to a brake system setting, or the like.

In still further addition, the adjusting the functional aspect of the vehicle based on the determined driver attention may comprise, for example, one or more of making one or more changes to one or more driver assistance systems of the vehicle such as for example making changes to parameters of one or more of an intelligent collision avoidance system, lane keeping aids, run-off road mitigation systems, cross traffic alert with or without auto brake systems, blind spot information systems, and surround view camera systems. The intelligent collision avoidance systems can detect and help the driver avoid a collision with other vehicles, pedestrians, cyclists, etc. The lane keeping aids may gently steer your car back into the lane if the vehicle is about to cross a lane marking without using the appropriate turn signal indicator and, if this steering intervention is not enough or if the driver keeps steering across the lane markings, the driver may be alerted with vibrations in the steering wheel. The run-off road mitigation driver assistance system helps prevent the driver and vehicle from accidentally leaving the road, wherein if the vehicle strays across the outer lane marking, the run-off road mitigation assistance system will help the driver steer the vehicle back onto the road and, further, if needed, it may also activate the brakes as may be necessary to help keep the vehicle on the road. The cross traffic alert assists the driver with an indication when reversing out of a parking space of approaching vehicles, and the system may also include auto brake wherein the vehicle brakes may be applied when an imminent collision is detected. The blind spot information system may provide an alert to the driver when a vehicle enters the driver's blind spot or approaches rapidly in a lane on either side of the vehicle, wherein the blind spot information system may alert the driver via a light in the left or right door side-view mirror. The surround view camera driver assist system includes cameras of the roadway imaging system 146 that provide a 360° bird's eye parking view so the driver can enter or exit any confined space including backing-up operations with confidence.

In accordance with the example embodiments herein, any one or more parameters of any one or more of the driver assist systems may selectively be adjusted based on the determined driver attention.

The driver imaging system 140 generates a signal in the form of video image data 212 representative of an image of the driver within the associated vehicle. In the example embodiment, the video image data 212 is converted using a head pose processing component 214 to generate head pose measurement (HPM) data 216 that is representative of the video image data 212. In the example embodiment, the HPM data 216 is HPM time-series data 218. In the example embodiment, the HPM time-series data 218 comprises a set of vectors representative of characteristics of the driver's head such as for example including and not limited to yaw, pitch, roll, eyes open/closed. In the example embodiment, the head pose processing component 214 may be performed by the processor device 122 executing the head pose determining logic 130 stored in the memory device 124. In a further example embodiment, the head pose processing component 214 may be performed by the driver imaging system 140 executing equivalent head pose determining logic stored in or otherwise local to the driver imaging system 140. In the embodiment wherein the head pose processing component 214 is performed by the driver imaging system 140, the pose processing component 214 may execute the equivalent head pose determining logic stored locally and by using dedicated processors local to the driver imaging system 140 that may be specifically adapted to perform the driver head pose determination quickly and efficiently thereby reducing the driver head pose determination processing burden on the network processing component 230. This helps to make the overall system more efficient and accurate. Thus, in the example embodiment, the HPM time-series data 218 comprises a reduced data set. That is, the raw video image data 212 and/or raw video signals representative of images of the driver's head are reduced to the HPM time-series data 218 comprising a reduced data set.

In addition, in the example embodiment, the group of vehicle sensors 14 generate a set of signals in the form of a stream of raw data and/or raw signals 222 representative of physical operating conditions of the vehicle 1. In the example embodiment the stream of data and/or signals 222 is converted using a pre/post event processing component 224 to generate pre/post event (PPE) data 226 that is representative of the stream of data and/or signals 222. In the example embodiment, the PPE data 226 is PPE time-series data 228. In the example embodiment, the pre/post event processing component 224 may be performed by the processor device 122 executing the PPE determining logic 132 stored in the memory device 124. In the example embodiment, the PPE time-series data 228 comprises a set of vectors representative of characteristics of the physical conditions of the vehicle such as for example including and not limited to speed, acceleration, distance to forward vehicle, braking condition, etc. Thus, in the example embodiment, the PPE time-series data 228 comprises a reduced data set. That is, the raw data and/or raw signals 222 representative of physical operating conditions of the vehicle 1 are reduced to the PPE time-series data 228 comprising a reduced data set.

In the example embodiment, the HPM time-series data 218 and the PPE time-series data 228 are synchronized and represent samples of the driver image and the vehicle physical condition taken at the same time or close to the same time, e.g. within approximately 100 msec. of each other. In the example embodiment, the HPM time-series data 218 and the PPE time-series data 228 represent samples of the driver image and the vehicle physical condition taken at intervals of about 0.25 seconds.

In further addition in the example embodiment, the trained network processing component 230 generates the driver attention score signal 240 based on the received signals, wherein the driver attention score signal 240 may selectively be used to adjust one or more functional aspects of the vehicle based on the determined driver attention. Operationally, a first signal representative of the head pose condition of the driver during a first time period is received by the trained network processing component 230. Further, a second signal representative of one or more physical characteristics of the vehicle operated during the first time period is received by the trained network processing component 230. The trained network processing component 230 determines the driver attention to the operation of the vehicle based on the first and second signals and generates the driver attention score signal 240 representative of the determined driver attention.

In accordance with the example embodiment, the trained network processing component 230 may be performed by the processor device 122 executing the neural network logic 134 stored in the memory device 124. In the example embodiment, the processor device 122 executing the neural network logic 134 stored in the memory device 124 may perform recurrent neural network processing on the HPM time-series data 218 and the PPE time-series data 228 to generate the driver attention score signal 240 representative of the determined driver attention. In accordance with a further example embodiment, the processor device 122 executing the neural network logic 134 stored in the memory device 124 may perform the recurrent neural network processing using a bi-directional long/short term memory (BLSTM) processing scheme to process the HPM time-series data 218 and the PPE time-series data 228 to generate the driver attention score signal 240 representative of the determined driver attention.

In accordance with the example embodiment, the determining the driver attention to the operation of the vehicle by neural network processing the time series data signals received by the neural network may process signals consisting essentially of the first set of time series data 218, and the second set of time series data 228. That is, the trained network processing component 230 may generate the driver attention score signal 240 based on the first and second sets of time series data 218, 228. The trained network processing component 230 may thereby generate the driver attention score signal 240 based on the first and second sets of time series data 218, 228 while dispensing with the need to process or otherwise handle any other signals that do not material affect the basic characteristics described herein, thereby dispensing with the need for time consuming and costly processing of driver image data directly. This helps to make the subject system and method fast and efficient.

In accordance with a further example embodiment, the determining the driver attention to the operation of the vehicle by neural network processing the time series data signals received by the neural network may only process signals consisting of the first set of time series data 218, and the second set of time series data 228. That is, the trained network processing component 230 may generate the driver attention score signal 240 based only on the first and second sets of time series data 218, 228, exclusively, thereby dispensing with the need for time consuming and costly processing of driver image data directly. This further helps to make the subject system and method fast and efficient.

In accordance with a further example embodiment, the neural network processing of the time series data signals received by the neural network need not be performed locally on-board the vehicle, but rather may be performed remotely off-board the vehicle such as at a management facility or the like. As mentioned, the control apparatus 100 includes a transmitter/receiver (transceiver) module 50 such as, for example, a radio frequency (RF) transmitter including one or more antennas 52 for wireless communication of one or more of the video image data 212, the stream of data and/or signals 222, the HPM time-series data 218, and/or the PPE time-series data 228 or the like between the vehicle and one or more destinations such as, for example, to one or more wireless services (not shown) having a corresponding receiver and antenna. The one or more signals received at the remote location can be processed there and the resultant data then may be transmitted back to the vehicle and received by the control apparatus 100 via the transmitter/receiver (transceiver) module 50. It is to be appreciated that pre-processing, e.g. normalization, compressive passing through the first layer of a neural network, pruning, and/or data reduction may be performed in situ (on the vehicle 1) to save or otherwise reduce data transmission overhead and/or save computation time at the remote location, thereby expediting the data analysis.

The control apparatus 100 is operative to communicate the acquired one or more of the video image data 212, the stream of data and/or signals 222, the HPM time-series data 218, and/or the PPE time-series data 228 to the one or more receivers in a raw data form, that is without processing the data, in a processed form such as in a compressed form, in an encrypted form and/or both as may be necessary or desired. In this regard, the control apparatus 100 may combine selected ones of the vehicle parameter data values into processed data representative of higher-level vehicle condition data such as, for example, data from the multi-axis acceleration sensors 17 may be combined with the data from the steering angle sensor 18 to determine excessive curve speed event data. Other hybrid event data relatable to the vehicle and driver of the vehicle and obtainable from combining one or more selected raw data items form the sensors includes, for example and without limitation, excessive braking event data, excessive curve speed event data, lane departure warning event data, excessive lane departure event data, lane change without turn signal event data, loss of video tracking event data, LDW system disabled event data, distance alert event data, forward collision warning event data, haptic warning event data, collision mitigation braking event data, ATC event data, ESC event data, RSC event data, ABS event data, TPMS event data, engine system event data, average following distance event data, average fuel consumption event data, and average ACC usage event data. Importantly, however, and in accordance with the example embodiments described herein, the control apparatus 100 is operative to store the acquired image data of the driver and/or of the interior of the vehicle in the memory 124, and to selectively communicate the acquired driver and vehicle interior image data to the one or more receivers via the transceiver 50.

In this regard the control apparatus 100 is operative to transmit the first signal 212 representative of the head pose condition of the driver during the first time period to an associated processing system, and to transmit the second signal 222 representative of the physical characteristic of the vehicle operated during the first time period to the associated processing system via the transmitter/receiver (transceiver) module 50. The control apparatus 100 is operative to determine the driver attention to the operation of the vehicle by receiving an operator attention signal from the associated processing system, wherein the received operator attention signal is representative of the driver attention to the operation of the vehicle based on the first and second signals transmitted to the associated processing system.

In addition to the above, the control apparatus 100 is operative to transmit the first set of time series data 218 representative of the head pose condition of the driver during the first time period and the second set of time series data 228 representative of the physical characteristic of the vehicle operated during the first time period to the associated processing system via the transmitter/receiver (transceiver) module 50. The control apparatus 100 is operative to determine the driver attention to the operation of the vehicle by receiving an operator attention signal from the associated processing system, wherein the received operator attention signal is representative of the driver attention to the operation of the vehicle based on the first and second signals transmitted to the associated processing system.

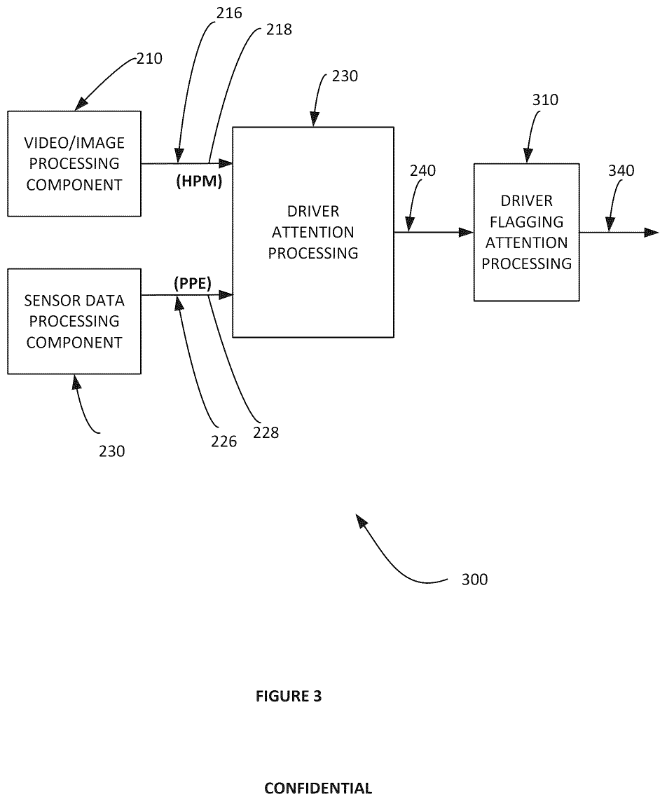

FIG. 3 is a functional block diagram depiction that illustrates details of a system 300 providing an indication of a flagging or waning driver attention to vehicle operation over time in accordance with a further example embodiment. The system 300 provides a verification over time of proper driver head pose during vehicle operation in accordance with an example embodiment. The system 300 in general includes a driver video/image processing component 210, a vehicle sensor data processing component 220, a trained network processing component 230, and a driver flagging attention processing component 310, that collectively render a driver flagging attention score signal 340.

In general, the system 300 determines driver flagging attention to an operation of the vehicle based on historical data regarding the same or different drivers performing the operation of the vehicle in ranges of states of attentiveness, and renders or otherwise generates or outputs a driver flagging attention score signal 340 representative of the determined flagging driver attention. In this disclosure, “flagging” attention is intended to represent “diminished” attention, or any attention that is noticed by the system 300 as being reduced (less/diminished) over time.

In the example embodiment, the system 300 receives a first signal 218 representative of a head pose condition of the driver during a first time period, and a second signal 228 representative of a physical characteristic of the vehicle operated during the first time period. Thereafter, the system 300 receives a further first signal 218 representative of the head pose condition of the driver during a second time period, and a further second signal 228 representative of the physical characteristic of the vehicle operated during the second time period.

The system 300 determines the driver attention to the operation of the vehicle based on the first and second signals, and determines a further driver attention to the operation of the vehicle based on the further first and second signals.

The driver flagging attention processing component 310 determines flagging driver attention to the operation of the vehicle by a comparison between the driver attention determined based on the first and second signals and the further driver attention determined based on the further first and second signals. In accordance with the example embodiment, the driver flagging attention processing component 310 may be performed by the processor device 122 executing the flagging determination logic 136 stored in the memory device 124.

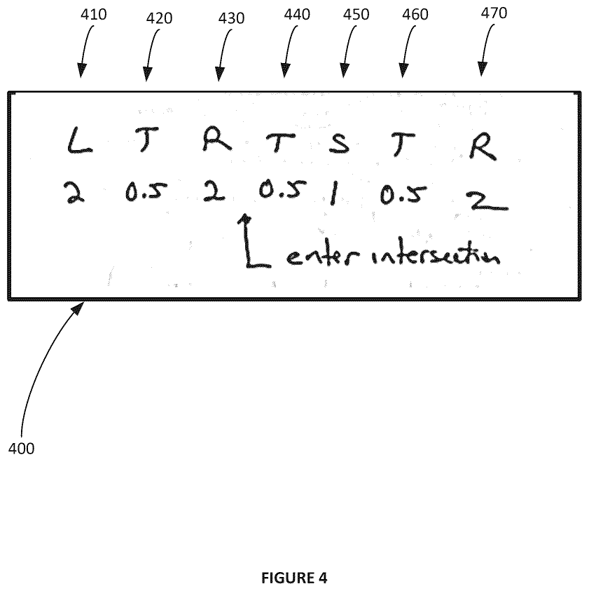

FIG. 4 is a plot representation 400 of separate driver vigilance activities against time useful for determining vigilance scores.

It is to be appreciated that the trained network processing component 230 of the Figures herein renders driver attention score signal 240 that is essentially representative of a measure of driver vigilance. The trained network processing component 230 of the Figures herein operate to determine the driver vigilance as an ongoing or persistent task. More particularly, the trained network processing component 230 of the Figures herein operate to determine the driver vigilance as an ongoing or persistent task using notions of “freshness” (how recently has the driver looked in a particular direction) and “sufficiency” (how long did the driver looked in a particular direction) to determine or otherwise calculate a measure of driver vigilance.

The trained network processing component 230 provides the measure of driver vigilance relative to a driver's present vigilance as well as to provide a measure of vigilance that may predict what is likely to happen in the near future.

The trained network processing component 230 of the Figures operates to provide this predicting in order to function and move in the world, which can be expected behavior in an at least somewhat predictable manner.

In a real world traffic context, a vehicle operator may expect to be able to cross the road in 5 seconds, after a red car has passed, given how far away it is and how fast it is moving.

Therefore, the network processing component 230 is trained in the example embodiments herein to have a “sense” of where the driver's vehicle is and wherein the other vehicles around the driver's vehicle are, and where the network processing component 230 can expect them to be in the next few seconds. Once the network processing component 230 is trained in this sense, the network processing component 230 is able to render the driver attention score signal 240 that is essentially representative of the measure of driver vigilance in this and in similar trained contexts.

To formalize these notions and using a real world example, extrapolating forward from a point in time, and this point should be reasonably ‘fresh’ (e.g. perhaps you should not blindly cross the road if you haven't looked at it in the last 30 seconds). Furthermore, a vehicle operator should have looked long enough at the situation to grasp it sufficiently well (judgement of speeds, motions and intentions requires a few seconds). Without this freshness and this sufficiency, timewise extrapolation becomes less reliable and therefore less useful. It is to be appreciated that the network processing component 230 is trained in this manner and, in operation uses the notions of “freshness” and “sufficiency” to determine or otherwise calculate a measure of driver vigilance.

By way of example, a driver may be best served during an operation of a vehicle by paying adequate attention to three (3) areas to look at: left (L), forward (F) and right (R), corresponding to the side mirrors and straight-ahead vision. The subject system is operable to determine what the driver is looking at from their head pose. It is to be appreciated also that the driver should look long enough at any area to grasp it (sufficiency training factor) and this looking should also not be too long ago in the past (freshness training factor). The system may classify the driver's head pose as having at least four states-looking left L, looking forward F, looking right R and being in transition between these states. The system may start a timer when a state is newly reached, monitoring for sufficiently long looking, which when reached, resets a determined vigilance for that area to maximum. When only half the required time is reached, the system refills with only half the vigilance.

When the driver stops looking at that area, the information is no longer brand new, and a predictive extrapolation starts. A second timer starts measuring how long ago it is since the driver last looked at the state he most recently left. From whatever state the driver started at, the determined vigilance now decreases.

The task then for a driver is to keep up his vigilance scores for each area, L, F, and R high enough to have them be useful (forming a reliable model of the environment). A driver's overall vigilance score is some function of the three scores (e.g. the minimum) and the vigilance/head pose requirements of the task being performed. Straight ahead looking might typically be most important (‘look where you are going’), but this is not necessarily always the case.

In accordance with embodiments herein, driver's vigilance is a selective, goal-dependent, task. For instance, in crossing a two-direction road, it behooves the driver to look both left and right, and the network processing component 230 of the Figures is trained accordingly, for example.

When driving in the right lane of a highway, the driver may arguably need less attention paid to the right side, and the network processing component 230 of the Figures is trained accordingly. When turning left at a “T” intersection, the driver may need to look both left and right and ideally in the proper order: most important to look at where he is first going, i.e. in the first, nearest, lane that he plans to cross, and the network processing component 230 of the Figures is trained accordingly. As a final example, when turning right at an intersection, cyclist safety dictates that the driver looks both left and right rather than assuming that there is no cyclist present. It may be enough for the driver to briefly glance right, but he should do so if he wants to be sure of not possibly crushing a cyclist, and the network processing component 230 of the Figures is trained accordingly. That is, each maneuver has its own ideal vigilance requirements, and the network processing component 230 of the Figures is trained accordingly.

In accordance with the examples herein, task performance may be examined retrospectively, so that the network processing component 230 of the Figures may thereby be trained. Given what happened, e.g. performing a left-hand turn at a “T” intersection, the system may inspect determined driver vigilance levels during the operation to determine, for example, whether the driver had sufficiently full L, F, and R vigilance levels. For instance, suppose the required vigilance levels of at least 50% for the left and 50% for the right. Then the system may determine whether the driver had or otherwise used these required vigilance levels.

FIG. 4 is a plot representation 400 of separate driver vigilance activities against time useful for determining vigilance scores. It may be postulated that it takes about 2 seconds to completely fill a driver's vigilance score in some direction, that any driver cannot have more than a 100% vigilance score, and also that any driver cannot have less than a 0% vigilance score. Then supposing also that it takes about 5 seconds for the driver's vigilance score to fully decay to zero (0%) from full (100%). Then further supposing that the driver wants to make a left-hand turn, first crossing one lane and then entering the next. Then presuming that traffic drives on the right, the driver therefore needs to look left first (the driver would cross the traffic coming from the left first), then right (the driver then would enter the lane of the traffic coming from the right). In an example of FIG. 4, the driver at time 410 looks left for 2 seconds, transits at 420 between left and right during 0.5 second, then looks right at 430 for 2 seconds, then transits at 440 for 0.5 seconds to straight at 450 for 1 second while moving across the first lane (so taking 2.5 seconds for this), and finally looks right again at 470 to verify the enter-ability of the lane for 2 seconds after a further 0.5 second transit at 460. The task for the network processing component 230 of the Figures to determine whether the driver had 50% left and right vigilance scores at all times.

The processing to determine vigilance scores may presume that all vigilance levels start at zero for illustrative purposes only. It is to be appreciated that in the real world the system has been acquiring information in an ongoing fashion. At time 0 the driver spends 2 seconds looking left, filling the L vigilance level 410 to a value of 1.0. The next time she looks left is after 4.5 seconds. His vigilance level has gone to 0.1 during that time (if vigilance takes 5 seconds to go from 1 to 0, then after 4.5 seconds it has gone by 0.9, to 0.1). The left-side vigilance is not fresh enough, per this example, with a deficit of 0.4 or 80% from our desired minimum level of 0.5.

With regard to the right-side vigilance level, the driver fills the vigilance level to 100% by looking for 2 seconds. A gap of 2 seconds decreases this by 40% down to 60%, over the minimum 0.5 level that is required. The determination is then that the left-side information is too old and therefore too unreliable. The driver's vigilance score might be 20% as measured relative to the 100% level of 0.5 desired, here taking the minimum of the left and right sides. The specific advice to the driver would be to look again where he is headed such as for example potentially crossing traffic coming from the left, rather than straight and refresh the information there.

This framework is applied after a maneuver and vigilance level may be measured after the fact of vehicle operation and the network then be trained thereon. Maneuvers may include lane change, turning, backing, general forward motion, etc, each with their vigilance requirements. The above example examined vigilance over time, but we may monitor general vigilance distribution, such as during driving straight in the right lane. It might be desirable for example to spend 80% of the time looking straight ahead, monitor the left 15% of the time, and dedicate 5% to the right side. This general head pose percentage ignores time details, however, and therefor the system may complement it with the maximum time looking away from any direction, for example, and thereby derive actionable vigilance advice.

The system is also operable to couple sensor signals to the driver's head pose and vigilance. For example, and supposing by way of the example that radar detects a vehicle overtaking on the left. The system is operable to render a vigilance score based on whether the driver turned his head to the left to see the vehicle before the radar detected the vehicle overtaking on the left. That is, the system is operable to render a vigilance score based on whether the driver was vigilant in actively monitoring what his peripheral vision or hearing detects. Here detecting the mere presence of the vehicle may be enough if lane changes are not necessary, so a half second of looking may be enough for the system to render a pass level vigilance score. The system is operable to render a vigilance score, establish desirable behaviors, and compare the driver's compliance with them over time.

The vigilance level calculated corresponds to how much the prediction can be trusted. Acting with a too low trust level is equivalent to unsafe driving. For simplicity the descriptions herein have used linear accrual and linear diminution of vigilance. However, it is to be appreciated that other time behaviors are possible and further that different and/or additional models may be implemented, wherein uncertainty typically does not increase linearly.

Therefore, in accordance with the example embodiments herein, vigilance levels for drivers are determined. The system is operable to establish what state or maneuver the driver is in or performing (e.g. changing lanes), associate a desirable behavior or statistic with it, and then calculate an overall or episodic (e.g. ‘when turning left, you . . . ’) level. As may be seen above, the system is operable to calculate a vigilance score using the framework presented here, along with providing actionable advice and/or adjusting any one or more functional aspects of the vehicle based on the determined driver attention/vigilance score.

FIG. 5 is a pictogram 500 showing details of data collection and manipulation data streams produced during an action for verifying driver head pose during maneuvers of a vehicle in accordance with an example embodiment.

The forward-facing camera (FFC) 147 sees ahead of the vehicle, and the actions (e.g. overtaking or approaching a vehicle ahead) can be deduced from the video data stream 510 it records. A driver facing camera DFC 141 sees the driver and measures his head pose (direction his head is facing) contemporaneously with the forward camera 147, producing a driver image data stream 520 that is converted to the HPM time-series data 218. For purposes of this description of the example embodiments and for ease of reference, “head pose” is that set of angles describing the orientation of the driver's head, that is, pitch (driver looking down or up), yaw (driver looking left or right), and roll (driver tilting his/her head to the left or right). In the example embodiment, the HPM time-series data 218 comprises a set of vectors representative of characteristics of the driver's head such as for example including and not limited to yaw, pitch, and roll. Eyes open and closed status may be measured also. The driver imaging system 140 generates a signal in the form of video image data 212 representative of an image of the driver within the associated vehicle. In the example embodiment, the video image data 212 is converted using a head pose processing component 214 to generate head pose measurement (HPM) data 216 that is representative of the video image data 212. In the example embodiment, the HPM data 216 is HPM time-series data 218. In the example embodiment, the head pose processing component 214 may be performed by the processor device 122 executing the head pose determining logic 130 stored in the memory device 124. In a further example embodiment, the head pose processing component 214 may be performed by the driver imaging system 140 executing equivalent head pose determining logic stored in or otherwise local to the driver imaging system 140. In the example embodiment, the HPM time-series data 218 comprises a set of vectors representative of characteristics of the driver's head such as for example including and not limited to yaw, pitch, roll, eyes open/closed.

In addition, the usual vehicle and driver signals (speed, acceleration, turn signal indicators, lane position, distance to vehicle ahead, steering angle, etc.) are recorded in the pre-and post-event PPE data stream. In the example embodiment the stream of data and/or signals 222 (FIG. 2) is converted using a pre/post event processing component 224 to generate pre/post event (PPE) data 226 that is representative of the stream of data and/or signals 222. In the example embodiment, the PPE data 226 is PPE time-series data 228. In the example embodiment, the pre/post event processing component 224 may be performed by the processor device 122 executing the PPE determining logic 132 stored in the memory device 124. In the example embodiment, the PPE time-series data 228 comprises a set of vectors representative of characteristics of the physical conditions of the vehicle such as for example including and not limited to speed, acceleration, distance to forward vehicle, braking condition, etc.

These streams are related to each other here with the goal of a machine determining whether the driver is paying proper attention given the maneuver. In the example embodiment, the HPM time-series data 218 and the PPE time-series data 228 are synchronized in the time axis 502, and represent samples of the driver image and the vehicle physical condition taken at the same time or close to the same time, e.g. within approximately 100 msec. of each other. In the example embodiment, the HPM time-series data 218 and the PPE time-series data 228 represent samples of the driver image and the vehicle physical condition taken at intervals of about 0.25 seconds.

In general, humans may analyze the forward-facing and driver-facing video, using perhaps also the PPE data to supplement their understanding. Questions humans may ask during the analysis include: did the driver overtake, for example, correctly, with proper attention, did the driver use the appropriate side view mirror, when did the driver use the side mirror, was the turn signal set when required, etc. Episodes of overtaking can be detected by looking for a target ahead, a lane change in some direction leading to the target disappearing, and a change back to the original lane, and are thus also evidenced in a form in the PPE data.

The analysts label episodes of overtaking or turning or lane changing or distance keeping as having good or bad attentional behavior. This same label now applies to the first and second sets of HPM and PPE time series data 218, 228. It is to be appreciated that in accordance with the example embodiments herein, the system 100 may merely use the first and second sets of HPM and PPE time series data 218, 228 streams as inputs to a neural network that learns to classify attention as proper or improper, without using either video stream when deployed. That is, first and second sets of HPM and PPE time series data 218, 228 streams are proxies for their respective full video streams, with the advantage of containing much smaller amounts of data and thus making analysis of them less computationally intensive.

In addition to the above and in accordance with a further embodiment, the network processing component 230 may be trained at least partially using the PPE time-series data 228 in conjunction with processing capabilities already inherent in the system 200 such as for example processing capabilities that detect subsets of severe data representative of severe events, e.g. excessive braking, collision mitigation braking, excessive curve speed, etc. These events have FFC video recorded when they occur, and the also include DFC video 212. Finding examples of poor driver attention may be aided by human analysists examining the videos from such severe events, as poor attention may well be the cause thereof. This can help to process the HPM time-series data 218 and the PPE time-series data 228 quickly and efficiently for thereby quickly and efficiently training the network processing component 230.

That is, the severe data representative of severe events that are determined automatically by the severe data detection processing capability can help direct the human analysis's attention in the sometimes large amount of PPE time-series data 228 to focus on important data relating to severe events as represented by the severe data. One such severe data detection processing capability is, for example, the Safety Direct® System commercially available from Bendix Commercial Vehicle Systems LLC may be installed on the vehicle.

In general, the attention evaluating system 200 is trained using binary data wherein a good/pass training value of a logical “1” may be assigned by the analyst for a maneuver that was performed by the driver to the satisfaction of the analyst and, similarly, a bad/fail training value of a logical “0” may be assigned by the analyst and/or automatically by machine logic such as for example Safety Direct® logic executed by a processor for a maneuver that was not performed by the driver to the satisfaction of he analyst. Once having been so trained on plural sets of HPM time-series data 218 and PPE time-series data 228 representative both good/pass (logical “1”) and bad/fail (logical “0”) training values, the system 200 is able to interpolate and/or otherwise to create continuous attentional output values between good (1) and bad (0). That is, in accordance with the example embedment, driver attention score signal 240 rendered by the system 200 may have a value in the range of 0.0-1.0.

In accordance with the embodiments herein, the processor device 122 executing the neural network logic 134 stored in the memory device 124 may perform the recurrent neural network processing using the BLSTM processing scheme to effectively form and/or otherwise provide a BLSTM neural network that processes the HPM time-series data 218 and the PPE time-series data 228 to generate the driver attention score signal 240 representative of the determined driver attention.

Overall, the training system looks for correspondence between HPM measures and the PPE values of maneuvers being executed, returning attentional values on an ongoing or episodic basis. If episodic, the time history of the entire maneuver is reviewed to derive a single attentional value for it. If ongoing, a multi-second or even minute long moving average filter or similar is/are overlaid onto the attentional values and see if this time average flags inattention or not.

There are various ways to determine the completion of an episode. This may take place for example after the vehicle has clearly arrived in a different lane (e.g. from the in lane position varying by +/−20 cm say, for 15 seconds, i.e. relocated and stably positioned in the new lane), or simply from a minute of data (for distance keeping, say), or return to say the speed set on the cruise control after an overtaking episode, or to a road ahead is free condition.

The methods and systems herein provide examples of smaller size proxy data that represent more complex scenarios than humans can see via video. Human operators may see videos and assign an attentional value to them, ‘dragging along’ the proxy HPM and PPE data as it were. The system is trained with the PPE and HPM data coupled to the attentional target value, learns the association between them, and then evaluates the new material it is given.

It is to be appreciated that although only a single example of the neural network logic 134 stored in the memory device 124 has been described, embodiments herein may also include two or more different neural networks that comprise neural network logic executable by the processor for determining driver behavior for different maneuvers. That is, separate sets of neural network logic may be provided that are each trained to specific maneuvers, all of which rendering driver performance scores for each of the respective maneuvers. Overall, the system may exercise different networks for different maneuvers. For example, there may be a distance keeping network implemented by the processor executing distance keeping neural network logic, a lane change network implemented by the processor executing lane change neural network logic, a turning at an intersection network implemented by the processor executing turning at an intersection neural network logic, a backing network implemented by the processor executing backing neural network logic, etc. In addition it is to be appreciated that the attentional value(s) need not immediately be available, and therefore that system may analyze after a maneuver is completed. The system may also differentiate between the attentional values for different maneuvers, pinpointing which maneuvers are performed well and which are not. The specific maneuver which just has been performed may be determined from the lane choice history, a map, the direction of motion, and so on.

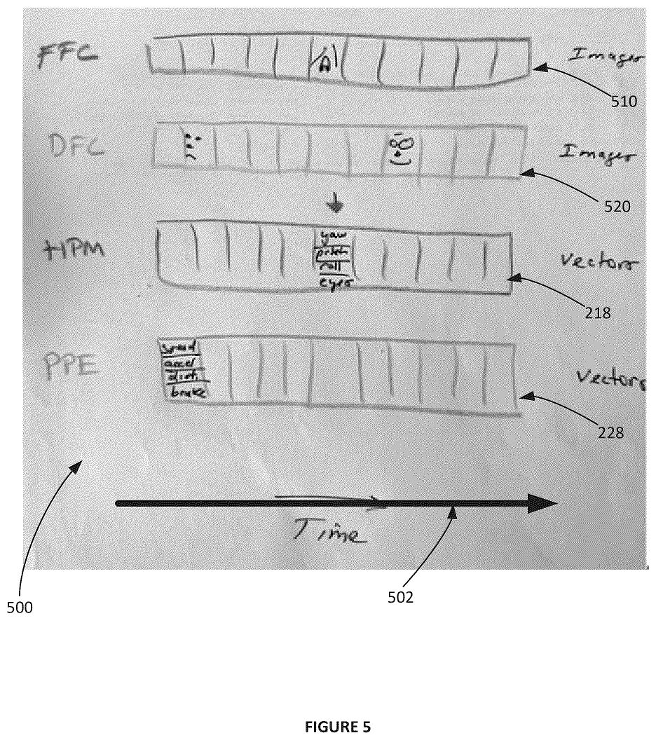

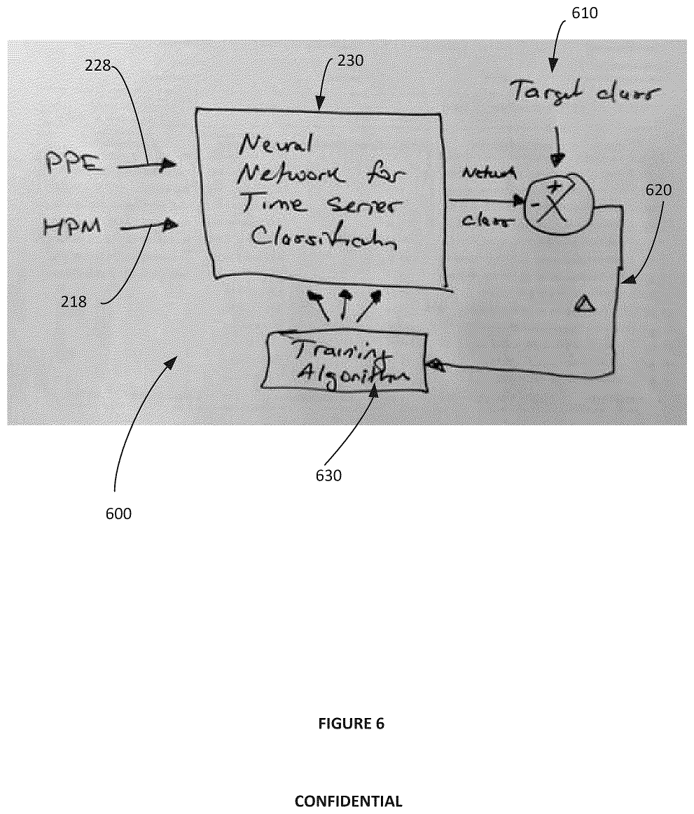

FIG. 6 is a functional block diagram depiction that illustrates details of a training system providing for training a driver attention processing component 230 in accordance with an embodiment. In particular, the Figure is a functional block diagram depiction that illustrates details of a training system 600 providing for training the BLSTM neural network 230 formed by a processor device 112 executing neural network logic 134 stored in a memory device 124 in accordance with an example embodiment. Humans using the training system 600 watch the video streams 510, 520 (FIG. 5) representative of an operator executing a maneuver while simultaneously feeding the time series data streams 218, 228 to the BLSTM neural network 230. The Human may judge the maneuver and enter a judgement value 610 to an adder thereby forming a difference signal 620 that is used by a training algorithm 630 to adjust weights and connections in the BLSTM neural network 230 based on the difference signal 620. In the example embodiment, the training algorithm 630 is a back-propagation training algorithm.

In the example embodiment, the procedure described above is performed repeatedly for many similar maneuvers by the driver (or other drivers).

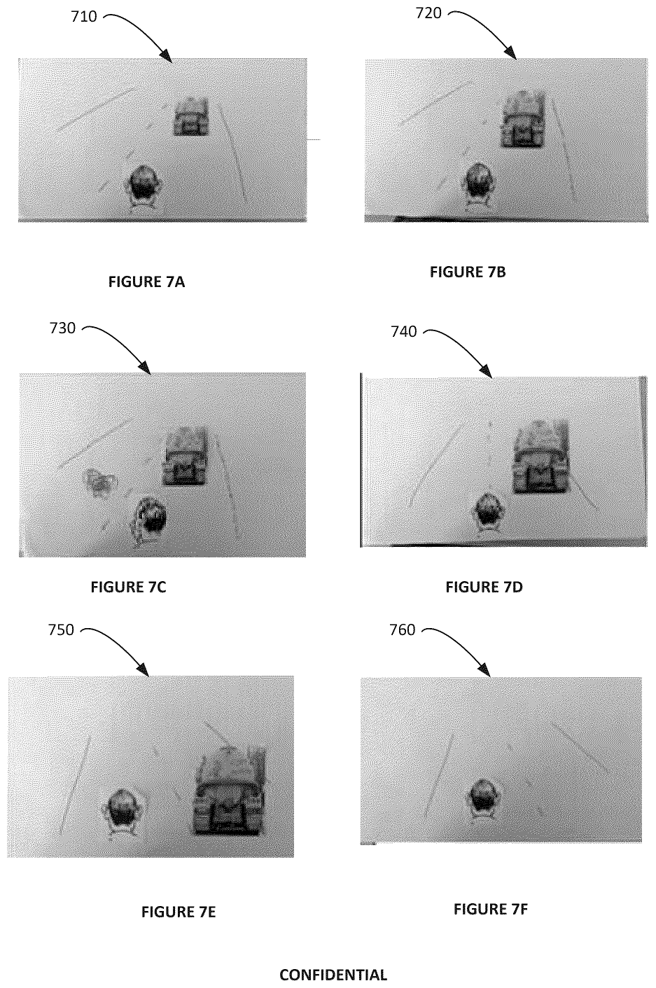

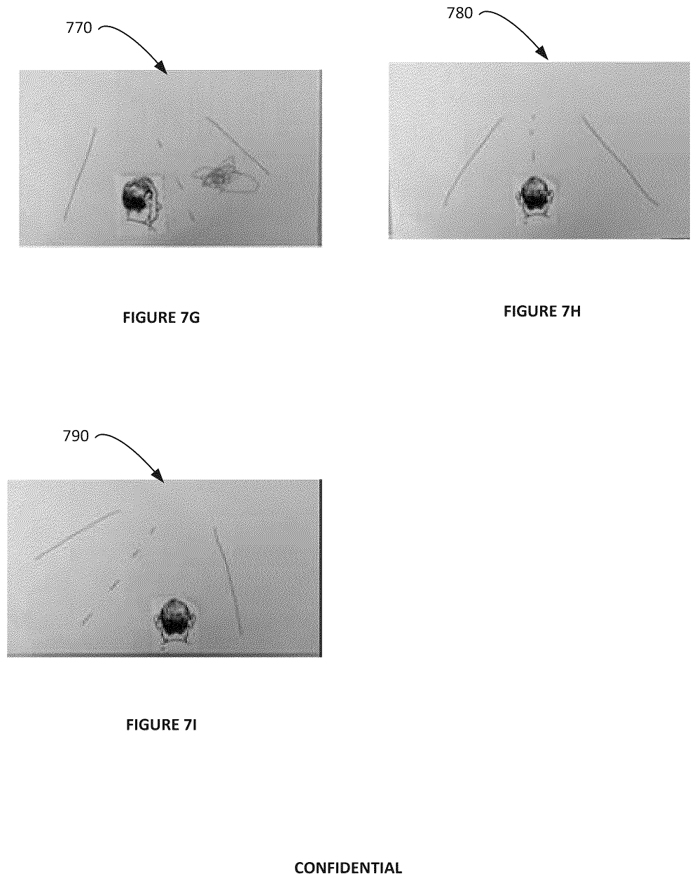

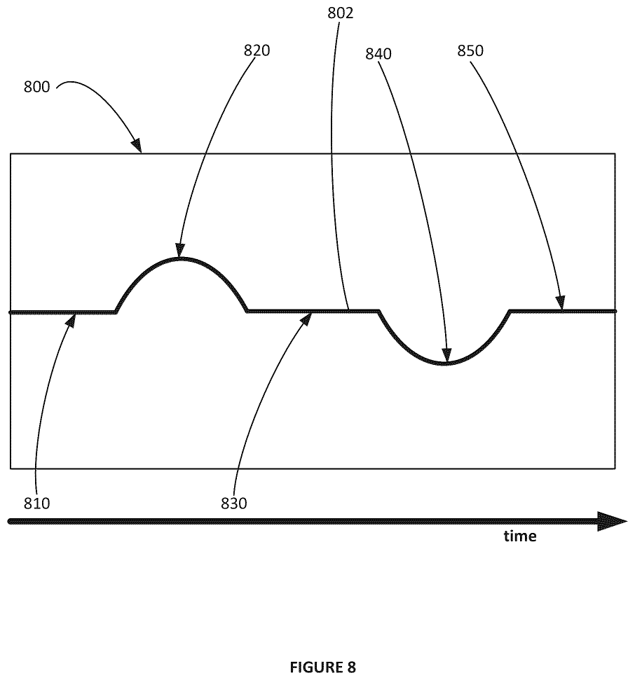

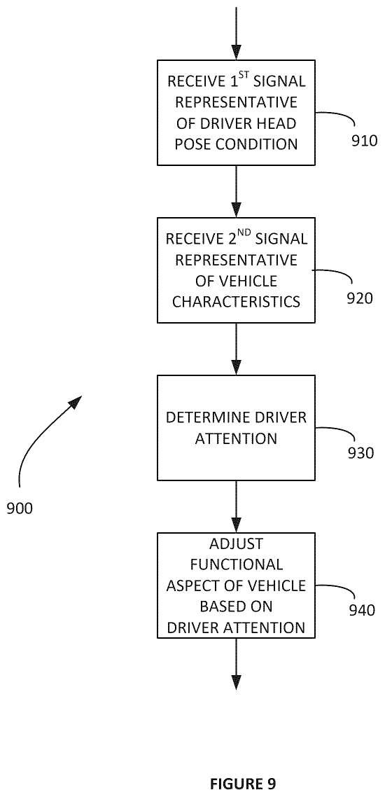

FIGS. 7A-7I are pictograms showing steps in training the BLSTM neural network formed by a processor device executing neural network logic stored in a memory device in accordance with an example embodiment, and FIG. 8 is a graph showing a yaw time history 800 corresponding to the pictograms of FIGS. 7A-7I used in training the BLSTM neural network formed by a processor device executing neural network logic stored in a memory device in accordance with an example embodiment.

In the first pictogram the image 710 shows the driver slowing the vehicle as he approaches another vehicle ahead. This corresponds with the portion 810 of the yaw timeline 801.

In the second pictogram the image 720 shows the driver getting closer to the vehicle ahead as he continues to approach the other vehicle ahead. This continues to correspond with the portion 810 of the yaw timeline 801.

In the third pictogram the image 730 shows the driver looking to the left and using a left turn signal of the vehicle during a time before moving to the left lane. This corresponds with the portion 820 of the yaw timeline 801.

In the fourth pictogram the image 740 shows the driver looking forward and moving the vehicle into the left lane. This corresponds with the portion 830 of the yaw timeline 801.

In the fifth pictogram the image 750 shows the driver passing the vehicle on the left. This continues to correspond with the portion 830 of the yaw timeline 801.

In the sixth pictogram the image 760 shows the driver having passed the vehicle on the left. This continues to correspond with the portion 830 of the yaw timeline 801.

In the seventh pictogram the image 770 shows the driver looking to the right and using a right turn signal of the vehicle during a time before moving back into the right lane. This corresponds with the portion 840 of the yaw timeline 801.

In the eighth pictogram the image 780 shows the driver looking forward and moving the vehicle into the right lane. This corresponds with the portion 850 of the yaw timeline 801.

In the ninth pictogram the image 790 shows the driver continuing to look forward having successfully passed the vehicle. This continues to correspond with the portion 850 of the yaw timeline 801.

FIG. 8 is a flow diagram showing a method 900 of controlling a vehicle based on driver attention to an operation of the vehicle in accordance with an example embodiment. with reference now to that Figure, the method 900 includes at 910 receiving a first signal by a trained network processing component 230 of a system 200, wherein the first signal is representative of a head pose condition of the driver during a first time period.

In accordance with an example embodiment, the receiving the first signal comprises receiving a first set of time series data representative of the head pose condition of the driver during the first time period.

In accordance with an example embodiment, the receiving the first signal comprises receiving a further first signal representative of the head pose condition of the driver during a second time period after the first time period.

The method 900 further includes at 920 receiving a second signal by the trained network processing component 230 of the system 200, wherein the second signal is representative of a physical characteristic of the vehicle operated during the first time period.

In accordance with an example embodiment, the receiving the second signal comprises receiving a second set of time series data representative of the physical characteristic of the vehicle operated during the first time period.

In accordance with an example embodiment, the receiving the second signal comprises receiving a second set of time series data representative of the physical characteristic of the vehicle operated during the first time period.

In accordance with an example embodiment, the receiving the second signal comprises receiving a further second signal representative of the physical characteristic of the vehicle operated during the second time period.

The method 800 further includes at 930 determining, by the network processing component 230 of the system 200, the driver attention to the operation of the vehicle based on the first and second signals.

In accordance with an example embodiment, the determining the driver attention to the operation of the vehicle comprises neural network processing the first and second sets of time series data to determine the driver attention to the operation based on the first and second sets of time series data processed by a neural network.

In accordance with an example embodiment, the determining the driver attention to the operation of the vehicle comprises neural network processing time series data signals received by the neural network and consisting essentially of the first set of time series data, and the second set of time series data.

In accordance with an example embodiment, the determining the driver attention to the operation of the vehicle comprises neural network processing time series data signals received by the neural network and consisting of the first set of time series data, and the second set of time series data.

In accordance with an example embodiment, the determining the driver attention to the operation of the vehicle comprises neural network processing the first and second sets of time series data to determine a maneuver performed by the driver operating the vehicle, and the driver attention to the maneuver.

In accordance with an example embodiment, the determining the driver attention to the maneuver comprises determining the driver attention to the maneuver as a current attention score based on the neural network processing the first and second sets of time series data based on driver attention scores trained to a neural network relative to sets of head pose conditions and associated physical characteristics of the vehicle operated during a plurality of training sessions of the vehicle performing the maneuver.

In accordance with an example embodiment, the determining the driver attention to the operation of the vehicle comprises determining a maneuver performed by the driver operating the vehicle by determining the maneuver as a particular maneuver based on the neural network processing the first and second sets of time series data based on driver attention scores trained to a neural network relative to sets of head pose conditions and associated physical characteristics of the vehicle operated during a plurality of training sessions to the neural network of the vehicle performing the particular maneuver.

In accordance with an example embodiment, the determining the driver attention to the operation of the vehicle comprises determining a further driver attention to the operation of the vehicle based on the further first and second signals, and determining flagging driver attention to the operation of the vehicle by a comparison between the driver attention determined based on the first and second signals and the further driver attention determined based on the further first and second signals.

The method 900 further includes at 940 adjusting a functional aspect of the vehicle based on the determined driver attention.

In accordance with various embodiments herein, the adjusting the functional aspect of the vehicle based on the determined driver attention comprises one or more of adjusting a content of a warning signal generated by the vehicle for warning the driver of potential danger relating to the vehicle operation, adjusting a timing of a warning signal generated by the vehicle for warning the driver of potential danger relating to the vehicle operation, adjusting a format of a warning signal generated by the vehicle for warning the driver of potential danger relating to the vehicle operation, adjusting a style of a warning signal generated by the vehicle for warning the driver of potential danger relating to the vehicle operation, and/or adjusting a parameter of one or more driver assistance systems of the vehicle.

In accordance with various embodiments herein, the adjusting the functional aspect of the vehicle comprises adjusting the functional aspect of the vehicle based on determined driver attention to a maneuver of the vehicle.

In accordance with various embodiments herein, the adjusting the functional aspect of the vehicle comprises adjusting the functional aspect of the vehicle based on a determined current attention score of the driver.

In accordance with various embodiments herein, the adjusting the functional aspect of the vehicle comprises adjusting a further functional aspect of the vehicle based on determined flagging driver attention.

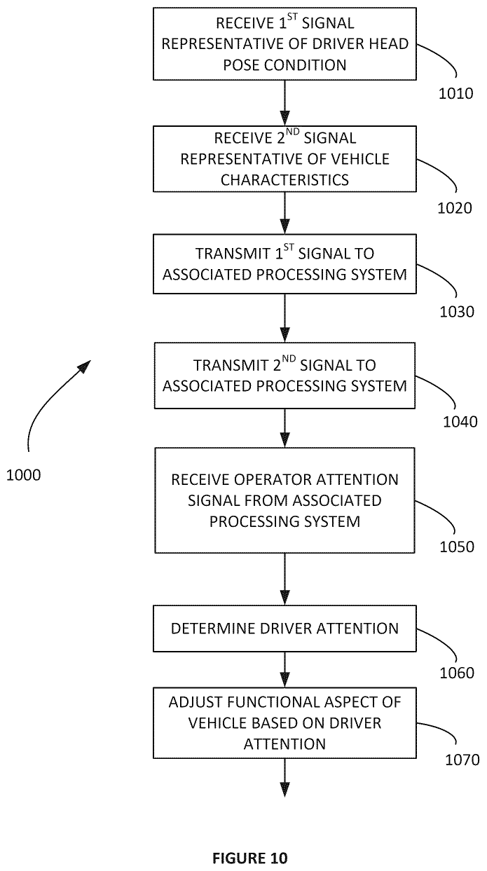

FIG. 10 is a flow diagram showing a method 1000 of controlling a vehicle based on driver attention to an operation of the vehicle in accordance with an example embodiment. with reference now to that Figure, the method 1000 includes at 1010 receiving a first signal by a trained network processing component 230 of a system 200, wherein the first signal is representative of a head pose condition of the driver during a first time period. The method 1000 further includes at 1020 receiving a second signal by the trained network processing component 230 of the system 200, wherein the second signal is representative of a physical characteristic of the vehicle operated during the first time period.

The method 1000 further includes at 1030 transmitting the first signal representative of the head pose condition of the driver during the first time period to an associated processing system.

The method 1000 further includes at 1040 transmitting the second signal representative of the physical characteristic of the vehicle operated during the first time period to the associated processing system.

The method 1000 further includes at 1050 receiving by the network processing component 230 of the system 200 an operator attention signal from the associated processing system.

The method 1000 further includes at 1060 determining, by the network processing component 230 of the system 200, the driver attention to the operation of the vehicle based on the first and second signals, wherein the determining the driver attention to the operation of the vehicle comprises the operator attention signal received from the associated processing system. In accordance with the embodiments herein, new and improved systems and methods are provided for monitoring the behavior of drivers operating vehicles, and determining a driver's vigilance (actively paying proper attention) to the vehicle operation. In this sense the method 1000 determines at 1060 by the network processing component 230 of the system 200 the driver's vigilance regarding the operation of the vehicle based on the first and second signals, wherein the determining the driver vigilance to the operation of the vehicle comprises the operator attention signal received from the associated processing system.

The method 1000 further includes at 1070 adjusting a functional aspect of the vehicle based on the determined driver attention.

It is to be understood that other embodiments will be utilized and structural and functional changes will be made without departing from the scope of the present invention. The foregoing descriptions of embodiments of the present invention have been presented for the purposes of illustration and description. It is not intended to be exhaustive or to limit the invention to the precise forms disclosed. Accordingly, many modifications and variations are possible in light of the above teachings. It is therefore intended that the scope of the invention be limited not by this detailed description.

1. A method of controlling a functional aspect of an associated vehicle based on driver attention to an operation of the vehicle, the method comprising:
receiving a first signal representative of a head pose condition of the driver during a first time period;
receiving a second signal representative of a physical characteristic of the vehicle operated during the first time period;
determining the driver attention to the operation of the vehicle based on the first and second signals; and
adjusting the functional aspect of the vehicle based on the determined driver attention.

2. The method according to claim 1, wherein the adjusting the functional aspect of the vehicle comprises:
generating a driver attention score signal representative of the determined driver attention; and
delivering the driver attention score signal to the associated vehicle,
wherein the associated vehicle is responsive to the driver attention score signal to effect the adjustment of the functional aspect.

3. The method according to claim 1, wherein:
the receiving the first signal comprises receiving a first set of time series data representative of the head pose condition of the driver during the first time period;
the receiving the second signal comprises receiving a second set of time series data representative of the physical characteristic of the vehicle operated during the first time period; and
the determining the driver attention to the operation of the vehicle comprises processing the first and second sets of time series data by one or more of neural network processing, time based processing and/or rules based processing to determine the driver attention to the operation based on the first and second sets of time series data processed by a neural network.

4. The method according to claim 3, wherein:
the determining the driver attention to the operation of the vehicle comprises neural network processing time series data signals received by the neural network and consisting essentially of:
the first set of time series data; and
the second set of time series data.

5. The method according to claim 3, wherein:
the determining the driver attention to the operation of the vehicle comprises neural network processing time series data signals received by the neural network and consisting of:
the first set of time series data; and
the second set of time series data.

6. The method according to claim 1, wherein:
the receiving the first signal comprises receiving a first set of time series data representative of the head pose condition of the driver during the first time period;
the receiving the second signal comprises receiving a second set of time series data representative of the physical characteristic of the vehicle operated during the first time period;
the determining the driver attention to the operation of the vehicle comprises processing the first and second sets of time series data by one or more of neural network processing, time based processing and/or rules based processing to determine:
a maneuver performed by the driver operating the vehicle; and
the driver attention to the maneuver; and
the adjusting the functional aspect of the vehicle comprises adjusting the functional aspect of the vehicle based on the determined driver attention to the maneuver.

7. The method according to claim 6, wherein:
the determining the driver attention to the maneuver comprises:
determining the driver attention to the maneuver as a current attention score based on:
the neural network processing the first and second sets of time series data based on:
driver attention scores trained to a neural network relative to sets of head pose conditions and associated physical characteristics of the vehicle operated during a plurality of training sessions of the vehicle performing the maneuver; and
the adjusting the functional aspect of the vehicle comprises adjusting the functional aspect of the vehicle based on the determined current attention score.

8. The method according to claim 6, wherein:
the determining the maneuver performed by the driver operating the vehicle comprises:
determining the maneuver as a particular maneuver based on:
the neural network processing the first and second sets of time series data based on:
driver attention scores trained to a neural network relative to sets of head pose conditions and associated physical characteristics of the vehicle operated during a plurality of training sessions to the neural network of the vehicle performing the particular maneuver; and
the adjusting the functional aspect of the vehicle comprises adjusting the functional aspect of the vehicle based on the determined current attention score.

9. The method according to claim 1, further comprising:
transmitting the first signal representative of the head pose condition of the driver during the first time period to an associated processing system; and
transmitting the second signal representative of the physical characteristic of the vehicle operated during the first time period to the associated processing system,
wherein the determining the driver attention to the operation of the vehicle comprises receiving an operator attention signal from the associated processing system, wherein the received operator attention signal is representative of the driver attention to the operation of the vehicle based on the first and second signals transmitted to the associated processing system.

10. The method according to claim 9, wherein:
the receiving the first signal comprises receiving a first set of time series data representative of the head pose condition of the driver during the first time period;
the receiving the second signal comprises receiving a second set of time series data representative of the physical characteristic of the vehicle operated during the first time period;
the transmitting the first signal to the associated processing system comprises transmitting the first set of time series data to the associated processing system; and
the transmitting the second signal to the associated processing system comprises transmitting the second set of time series data to the associated processing system.

11. The method according to claim 1, further comprising:
receiving a further first signal representative of the head pose condition of the driver during a second time period after the first time period;
receiving a further second signal representative of the physical characteristic of the vehicle operated during the second time period;
determining a further driver attention to the operation of the vehicle based on the further first and second signals;
determining flagging driver attention to the operation of the vehicle by a comparison between the driver attention determined based on the first and second signals and the further driver attention determined based on the further first and second signals; and
adjusting a further functional aspect of the vehicle based on the determined flagging driver attention.

12. The method according to claim 1, wherein:
the adjusting the functional aspect of the vehicle based on the determined driver attention comprises one or more of:
adjusting a content of a warning signal generated by the vehicle for warning the driver of potential danger relating to the vehicle operation;
adjusting a timing of a warning signal generated by the vehicle for warning the driver of potential danger relating to the vehicle operation;
adjusting a format of a warning signal generated by the vehicle for warning the driver of potential danger relating to the vehicle operation;
adjusting a style of a warning signal generated by the vehicle for warning the driver of potential danger relating to the vehicle operation; and/or
adjusting a parameter of one or more driver assistance systems of the vehicle.

13. The method according to claim 1, wherein:
the adjusting the functional aspect of the vehicle comprises:
generating a signal that adjusts the functional aspect of the associated vehicle, wherein the generated signal causes the associated vehicle to adjust the functional aspect of the vehicle based on the generated signal.

14. An apparatus controlling a functional aspect of an associated vehicle based on driver attention to an operation of the vehicle, the apparatus comprising:
a processor device;
a non-transitory memory device operatively coupled with the processor device; and
vehicle control logic stored in the non-transient memory device,
wherein the processor device is operable to execute the control logic to:
receive a first signal representative of a head pose condition of the driver during a first time period;
receive a second signal representative of a physical characteristic of the vehicle operated during the first time period;
determine the driver attention to the operation of the vehicle based on the first and second signals; and
adjust the functional aspect of the vehicle based on the determined driver attention.

15. The apparatus according to claim 14, wherein the processor is operable to execute the control logic to adjust the functional aspect of the vehicle by:
generating a driver attention score signal representative of the determined driver attention; and
delivering the driver attention score signal to the associated vehicle,
wherein the associated vehicle is responsive to the driver attention score signal to effect the adjustment of the functional aspect.

16. The apparatus according to claim 14, wherein the processor is operable to execute the control logic to:
receive the first signal by receiving a first set of time series data representative of the head pose condition of the driver during the first time period;
receiving the second signal by receiving a second set of time series data representative of the physical characteristic of the vehicle operated during the first time period; and
determine the driver attention to the operation of the vehicle by processing the first and second sets of time series data by one or more of neural network processing, time based processing and/or rules based processing to determine the driver attention to the operation based on the first and second sets of time series data processed by a neural network.

17. The apparatus according to claim 14, wherein the processor device is operable to execute the control logic to:
receive the first signal by receiving a first set of time series data representative of the head pose condition of the driver during the first time period;
receive the second signal by receiving a second set of time series data representative of the physical characteristic of the vehicle operated during the first time period;
determine the driver attention to the operation of the vehicle by processing the first and second sets of time series data by one or more of neural network processing, time based processing and/or rules based processing to determine:
a maneuver performed by the driver operating the vehicle; and
the driver attention to the maneuver; and
adjust the functional aspect of the vehicle by adjusting the functional aspect of the vehicle based on the determined driver attention to the maneuver.

18. The apparatus according to claim 14, wherein the processor device is operable to execute the control logic to:
transmit the first signal representative of the head pose condition of the driver during the first time period to an associated processing system; and
transmit the second signal representative of the physical characteristic of the vehicle operated during the first time period to the associated processing system,
wherein the determining the driver attention to the operation of the vehicle comprises receiving an operator attention signal from the associated processing system, wherein the received operator attention signal is representative of the driver attention to the operation of the vehicle based on the first and second signals transmitted to the associated processing system.

19. The apparatus according to claim 14, wherein the processor device is operable to execute the control logic to:
receive a further first signal representative of the head pose condition of the driver during a second time period after the first time period;
receive a further second signal representative of the physical characteristic of the vehicle operated during the second time period;
determine a further driver attention to the operation of the vehicle based on the further first and second signals;
determine flagging driver attention to the operation of the vehicle by a comparison between the driver attention determined based on the first and second signals and the further driver attention determined based on the further first and second signals; and
adjust a further functional aspect of the vehicle based on the determined flagging driver attention.

20. The apparatus according to claim 14, wherein the processor device is operable to execute the control logic to:
adjust the functional aspect of the vehicle based on the determined driver attention by one or more of:
adjusting a content of a warning signal generated by the vehicle for warning the driver of potential danger relating to the vehicle operation;
adjusting a timing of a warning signal generated by the vehicle for warning the driver of potential danger relating to the vehicle operation;
adjusting a format of a warning signal generated by the vehicle for warning the driver of potential danger relating to the vehicle operation;
adjusting a style of a warning signal generated by the vehicle for warning the driver of potential danger relating to the vehicle operation; and/or
adjusting a parameter of one or more driver assistance systems of the vehicle.
